(19) United States
(12) Patent Application Publication
(10) Pub. No.: US 2011/0231616 A1
(43) Pub. Date: Sep. 22, 2011

(54) DATA PROCESSING METHOD AND SYSTEM

(76) Inventor: KENNETH CHENGHAO LIN, Shanghai (CN)

(21) Appl. No.: 13/118,360

(22) Filed: May 27, 2011

Related U.S. Application Data
(63) Continuation of application No. PCT/CN2009/001346, filed on Nov. 30, 2009.

(30) Foreign Application Priority Data
Nov. 28, 2008 (CN) 200810203777.2
Nov. 28, 2008 (CN) 200810203778.7
Feb. 11, 2009 (CN) 200910046117.2
Sep. 29, 2009 (CN) 200910208432.0

(51) Int. Cl. G06F 12/00

(52) U.S. Cl. 711/147; 711/E12.001

(57) ABSTRACT

A configurable multi-core structure is provided for executing a program. The configurable multi-core structure includes a plurality of processor cores and a plurality of configurable local memory respectively associated with the plurality of processor cores. The configurable multi-core structure also includes a plurality of configurable interconnect structures for serially interconnecting the plurality of processor cores. Further, each processor core is configured to execute a segment of the program in a sequential order such that the serially-interconnected processor cores execute the entire program in a pipelined way. In addition, the segment of the program for one processor core is stored in the configurable local memory associated with the one processor core along with operation data to and from the one processor core.

### CROSS-REFERENCES TO RELATED APPLICATIONS

This application claims the priority of PCT application no. PCT/CN2009/001346, filed on Nov. 30, 2009, which claims the priority of Chinese patent application no. 200810203778.7, filed on Nov. 28, 2008, Chinese patent application no. 200810203777.2, filed on Nov. 28, 2008, Chinese patent application no. 200910046117.2, filed on Feb. 11, 2009, and Chinese patent application no. 200910208432.0, filed on Sep. 29, 2009, the entire contents of all of which are incorporated herein by reference.

### FIELD OF THE INVENTION

The present invention generally relates to integrated circuit (IC) design and, more particularly, to the methods and systems for data processing in ICs.

### BACKGROUND

Tracking the Moore's Law, the feature size of transistors shrinks following steps of 65 nm, 45 nm, and 32 nm . . . , thus the number of transistors integrated on a single chip has exceeded a billion by now. However, there is no significant breakthrough on EDA tools for the last 20 years ever since the introduction of logic synthesizing, placing and routing tools which improved the back-end IC design productivity in the 80's of the last century. This phenomenon makes the front-end IC design, especially the verification, increasingly difficult to handle the increasing scale of a single chip. Therefore, design companies are shifting toward multi-core processor, i.e., a chip includes multiple relatively simple cores, to lower the difficulty of chip design and verification while gaining performance from the single chip.

Conventional multi-core processors integrate a number of processor cores for parallel program execution to improve chip performance. Thus, for these conventional multi-core processors, parallel programming may be required to make full use of the processing resources. However, the operating system does not have fundamental changes in its allocation and management of resources, and generally allocates the resources equally in a symmetrical manner. Thus, although the number of processor cores may perform parallel computing, for a single program thread, its serial execution nature makes the conventional multi-core structure impossible to realize true pipelined operations. Further, current software still includes a large amount of programs that require serial execution. Therefore, when the number of processor cores reaches a certain value, the chip performance cannot be further increased by increasing the number of the processor cores. In addition, with the continuous improvement on the semiconductor manufacturing process, the internal operating frequency of multi-core processors have been much higher than the operating frequency of the external memory. Simultaneous memory access by multiple processor cores has become a major bottleneck for the chip performance, and the multiple processor cores in parallel structure executing programs which are in serial by nature may not realize the expected chip performance gains.

The disclosed methods and systems are directed to solve one or more problems set forth above and other problems.

### BRIEF SUMMARY OF THE DISCLOSURE

One aspect of the present disclosure includes a configurable multi-core structure for executing a program. The configurable multi-core structure includes a plurality of processor cores and a plurality of configurable local memory respectively associated with the plurality of processor cores. The configurable multi-core structure also includes a plurality of configurable interconnect structures for serially interconnecting the plurality of processor cores. Further, each processor core is configured to execute a segment of the program in a sequential order such that the serially-interconnected processor cores execute the entire program in a pipelined way. In addition, the segment of the program for one processor core is stored in the configurable local memory associated with the one processor core along with operation data to and from the one processor core.

Another aspect of the present disclosure includes a configurable multi-core structure for executing a program. The configurable multi-core structure includes a first processor core configured to be a first stage of a macro pipeline operated by the multi-core structure and to execute a first code segment of the program, and a first configurable local memory associated with the first processor core and containing the first code segment. The configurable multi-core structure also includes a second processor core configured to be a second stage of the macro pipeline and to execute a second code segment of the program, and a second configurable local memory associated with the second processor core and containing the second code segment. Further, the configurable multi-core structure includes a plurality of configurable interconnect structures for serially interconnecting the first processor core and the second processor core.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary program segmenting and allocating process consistent with the disclosed embodiments;

FIG. 2 illustrates an exemplary an exemplary segmenting process consistent with the disclosed embodiments;

FIG. 3 illustrates an exemplary multi-core processing environment consistent with the disclosed embodiments;

FIG. 4A illustrates an exemplary address mapping to determine code segment addresses consistent with the disclosed embodiments;

FIG. 4B illustrates another exemplary address mapping to determine code segment addresses consistent with the disclosed embodiments;

FIG. 5 illustrates an exemplary data exchange among processor cores consistent with the disclosed embodiments;

FIG. 6 illustrates an exemplary configuration of a multi-core structure consistent with the disclosed embodiments;

FIG. 7 illustrates an exemplary multi-core self-testing and self-repairing system consistent with the disclosed embodiments;

FIG. 8A illustrates an exemplary register value exchange between processor cores consistent with the disclosed embodiments;

FIG. 8B illustrates another exemplary register value exchange between processor cores consistent with the disclosed embodiments;

FIG. 9 illustrates another exemplary register value exchange between processor cores consistent with the disclosed embodiments;

FIG. 10A illustrates an exemplary configuration of processor core and local data memory consistent with the disclosed embodiments;

FIG. 10B illustrates another exemplary configuration of processor core and local data memory consistent with the disclosed embodiments;

FIG. 100 illustrates another exemplary configuration of processor core and local data memory consistent with the disclosed embodiments;

FIG. 11A illustrates a typical structure of a current system-on-chip (SOC) system;

FIG. 11B illustrates an exemplary SOC system structure consistent with the disclosed embodiments;

FIG. 11C illustrates an exemplary SOC system structure consistent with the disclosed embodiments;

FIG. 12A illustrates an exemplary pre-compiling processing consistent with the disclosed embodiments;

FIG. 12B illustrates another exemplary pre-compiling processing consistent with the disclosed embodiments;

FIG. 13A illustrates another exemplary multi-core structure consistent with the disclosed embodiments;

FIG. 13B illustrates an exemplary all serial configuration of multi-core structure consistent with the disclosed embodiments;

FIG. 13C illustrates an exemplary serial and parallel configuration of multi-core structure consistent with the disclosed embodiments; and

FIG. 13D illustrates another exemplary multi-core structure consistent with the disclosed embodiments.

### DETAILED DESCRIPTION

Reference will now be made in detail to exemplary embodiments of the invention, which are illustrated in the accompanying drawings. The same reference numbers may be used throughout the drawings to refer to the same or like parts.

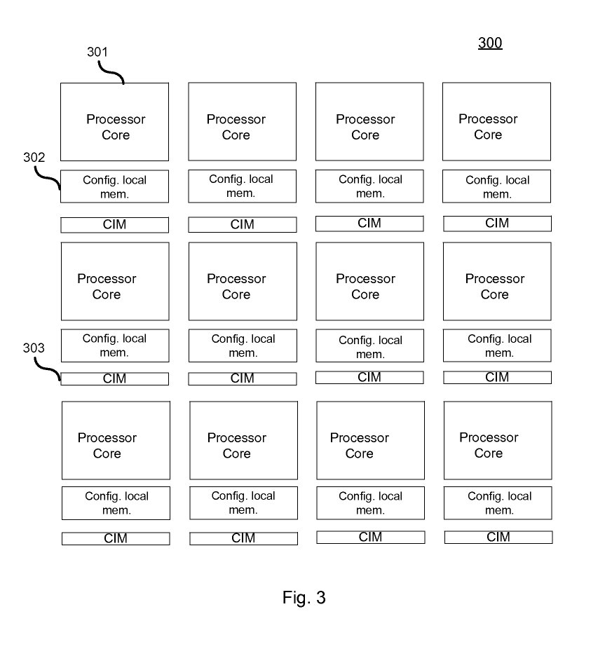

FIG. 3 illustrates an exemplary multi-core processing environment 300 consistent with the disclosed embodiments. As shown in FIG. 3, multi-core processing environment 300 or multi-core processor 300 may include a plurality of processor cores 301, a plurality of configurable local memory 302, and a plurality of configurable interconnecting modules (CIM) 303. Other components may also be included.

A processor core, as used herein, may refer to any appropriate processing unit capable of performing operations and data read/write through executing instructions, such as a central processing unit (CPU), a digital signal processor (DSP), or an application specific integrated circuit (ASIC), etc. Configurable local memory 301 may include any appropriate memory module that can be configured to store instructions and data, to exchange data between processor cores, and to support different read/write modes.

Configurable interconnecting modules 303 may include any interconnecting structures that can be configured to interconnect the plurality of processor cores into different configurations or groups. Configurable interconnecting modules 303 may also interconnect internal processing units of processor cores to external processor cores or processing units. Further, although not shown in FIG. 3, other components may also be included. For example, certain extension modules may be included, such as shared memory for saving data in case of overflow of the configurable local memory 302 and for transferring shared data between the processor cores, direct memory access (DMA) for directing access to the configurable local memory 302 by other modules in addition to the processor cores 301, and exception handling modules for handling exceptions in the processor cores 301 and configurable local memory 302.

Each processor core 301 may correspond to a configurable local memory 302 (e.g., one directly below the processor core) to form a configurable entity to be used, for example, as a single stage of a pipelined operation. The plurality of processor cores 301 may be configured in different manners depending on particular applications. For example, several processor cores 301 (e.g., along with corresponding configurable local memory 302) may be configured in a serial connection to form a serial multi-core configuration. Of course, certain processor cores 301 (e.g., along with corresponding configurable local memory 302) may be configured in a parallel connection to form a parallel multi-core configuration, or some processor cores 301 may be configured into a serial multi-core configuration while some other processor cores 301 may be configured into a parallel multi-core configuration to form a mixed multi-core configuration. Any other appropriate configurations may be used.

A single processor core 301 may execute one or more instructions per cycle (single or multiple issues). Each processor core 301 may operate a pipeline when executing programs, so-called an internal pipeline. When a number of processor cores 301 are configured into the serial multi-core configuration, the interconnected processor cores 301 may execute a large number of instructions per cycle (a large scale multi-issue) when configured properly. More particularly, the serially-interconnected processor cores 301 may form a pipeline hierarchy, so-called an external pipeline or a macro-pipeline. In the macro-pipeline, each processor core 301 may act as one stage of the macro or external pipeline carried out by the serially-interconnected processor cores 301. Further, this concept of pipeline hierarchy can be extended to even higher levels, for example, where the serially-interconnected processor cores 301 may itself act as one stage of a level-three pipeline, etc.

Each processor core 301 may include one or more execution unit, a program counter, and other components, such as a register file. The processor core 301 may execute any appropriate type of instructions, such as arithmetic instructions, logic instructions, conditional branch and jump instructions, and exception trap and return instructions. The arithmetic instructions and logical instructions may include any instructions for arithmetic and/or logic operations, such as multiplication, addition/subtraction, multiplication-addition/subtraction, accumulating, shifting, extracting, exchanging, etc., and any appropriate fixed-point and floating point operations. The number of processor cores included in the serially-interconnected or parallelly-connected processor cores 301 may be determined based on particular applications.

Each processor core 301 is associated with a configurable local memory 302 including instruction memory and configurable data memory for storing code segments allocated for a particular processor core 301 as well as any data. The configurable local memory 302 may include one or more memory modules, and the boundary between the instruction memory and configurable data memory may be changed based on configuration information. Further, the configurable data memory may be configured into multiple sub-modules after the size and boundary of the configurable data memory is determined. Thus, within a single data memory, the boundary between different sub-modules of data memory can also be configured based on a particular configuration.

Configurable interconnect modules 303 may be configured to provide interconnection among different processor cores 301, between processor cores 301 and memory (e.g., configurable local memory, shared memory, etc.), between processor cores and other components including external components. The plurality of configurable interconnect module 303 may be in any appropriate form, such as an interconnected network, a switching fabric, or other interconnection topology.

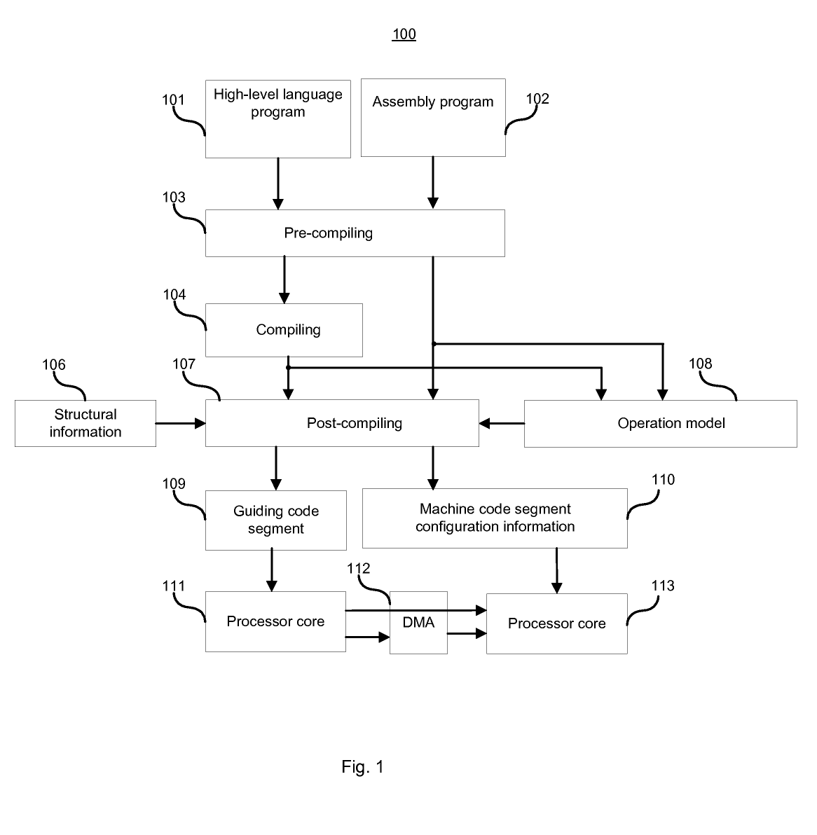

For the serially-interconnected processor cores 301, a computer program generally written for a single processor may need to be processed so as to utilize the serial multi-core configuration, i.e., the serial multi-issue processor structure. The computer program may be segmented and allocated to different processor cores 301 such that the external pipeline can be used efficiently and the load balance of the multiple processor cores 301 can be substantially improved. FIG. 1 illustrates an exemplary program segmenting and allocating process 100 consistent with the disclosed embodiments.

As shown in FIG. 1, the computer program for the multi-core processor may include any computer program written in any appropriate programming language. For example, the computer program may include a high-level language program 101 (e.g., C, Java, and Basic) and/or an assembly language program 102. Other program languages may also be used.

The computer program may be processed before being compiled, i.e., pre-compiling processing 103. Compiling, as used herein, may generally refer to a process to convert source code of the computer program into object code by using, for example, a compiler. During pre-compiling processing 103, the source code of the computer program is processed for the subsequent compiling process. For example, during pre-compiling processing 103, a “call” may be expanded to replace the call with the actual code of the call such that no call appears in the computer program. Such call may include, but not limited to, a function call or other types of calls. FIG. 12A illustrates an exemplary pre-compiling processing.

As shown in FIG. 12A, original program code 1201 includes program code 1, program code 2, function call A, program code 3, program code 4, function call B, program code 5, and program code 6. The number of program codes and function calls are used only for illustrative purposes, and any number of program codes and/or function calls may be included.

Function A 1203 may include function A code 1, function A code 2, and function A code 3, while function B 1204 may include function B code 1, function B code 2, and function B code 3. During pre-compiling, the program code 1201 may be expanded such that the call sentence itself is substituted by the code section called. That is, the A and B function calls are replaced with the corresponding function codes. The expanded program code 1202 may thus include program code 1, program code 2, function A code 1, function A code 2, function A code 3, program code 3, program code 4, function B code 1, function B code 2, function B code 3, program code 5, and program code 6.

Returning to FIG. 1, after the pre-compiling processing 103, any non-object code of the computer program may be compiled during compiling 104 to generated assembly code in executing sequences. For original assembly code already in executing sequences, the compiling process 104 may be skipped. The compiled code or any original object code of the computer program may be further processed in post-compiling 107. For example, the object code may be segmented into a plurality of code segments based on the type of operation and the load of each processor core 301, and the code segments may be further allocated to corresponding processor cores 301. FIG. 12B illustrates an exemplary pre-compiling processing.

As shown in FIG. 12B, original object code 1205 includes object code 1, object code 2, object code 3, object code 4, A loop, object code 5, object code 6, object code 7, B loop 1, B loop 2, object code 8, object code 9, and object code 10. An object code may be an object code normally compiled to be executed in sequence. The number of object codes and loops are used only for illustrative purposes, and any number of object codes and/or loops may be included.

During post-compiling 107, the original object code 1205 is segmented into a plurality of code segments, each being allocated to a processor core 301 for executing. For example, the original object code 1205 is segmented into code segments 1206, 1207, 1208, 1209, 1210, and 1211. Code segment 1206 includes object code 1, object code 2, and object code; code segment 1207 includes A loop; code segment 1208 includes object code 5, object code 6, and object code 7; code segment 1209 includes B loop 1; code segment 1210 includes B loop 2; and code segment 1211 includes object code 8, object code 9, and object code 10. Other segmentations may also be used.

Because the code segments generated in the post-compiling process 10 are for individual processor cores 301, the segmentations are performed based on the configuration and characteristics of the individual processor cores 301. Returning FIG. 1, the assembly code stream, i.e., the front-end code stream, from the compiling 104 and/or pre-compiling 103 may be run on a particular operation model 108 to determine the configuration information of the interconnected processor cores and/or the configuration or characteristics of individual processor cores 301.

That is, operation model 108 may be a simulation of the interconnected processor cores 301 and/or the multi-core processor 300 to execute the assembly code from a complier in the compiling process 104. The front-end code stream running in the operation model 108 may be scanned to obtain information such as execution cycles needed, any jump/branch and the jump/branch addresses, etc. This information and other information may then be analyzed to determine segment information (i.e., how to segment the compiled code). Alternatively or optionally, the executable object code in post-compiling process may also be parsed to determine information such as a total instruction count and to generate code segments based on such information.

For example, the object code may be segmented based on, for example, the number of instruction execution cycles or time, and/or the number of the instructions. Based on the instruction execution cycles or time, the object code can be segmented into a plurality of code segments with equal or substantially similar number of execution cycles or similar amount of execution time. Or based on the number of the instructions, the object code can be segmented into a plurality of code segments with equal or similar number of instructions.

Alternatively, predetermined structural information 106 may be used to determine the segment information. Such structural information 106 may include pre-configured configuration, operation, and other information of the interconnected processor cores 301 and/or the multi-core processor 300 such that the compiled code can be segmented properly for the processor cores 301. For example, based on the predetermined structural information 106, the code stream may be segmented into a plurality of code segments with equal or similar number of instructions, etc.

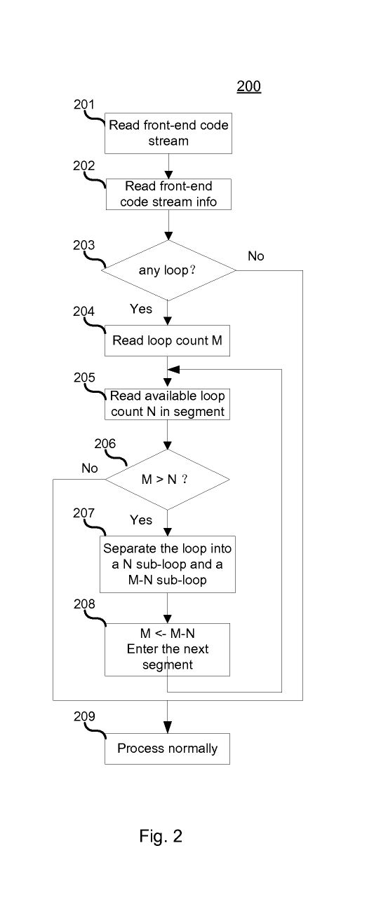

When the code segmentation is performed, the code stream may include program loops. It may be desired to avoid segmenting the program loops, i.e., an entire loop is in a single code segment (e.g., in FIG. 12B). However, under certain circumstances, a program loop may also need to be segmented. FIG. 2 illustrates an exemplary segmenting process 200 consistent with the disclosed embodiments.

The segment process 200 may be performed by a host computer or by the multi-core processor. As shown in FIG. 2, the host computer reads in a front-end code stream to be segmented (201), and also read in configuration information about the code stream (202). This configuration information may contain segment length, available loop count N, and other appropriate information. Further, the host computer may read in certain length of the code stream at one time and may determines whether there is any loop within the code read-in (203). If the host computer determines that there is no loop within the code (203, No), the host computer may process the code segmentation normally on the read-in code (209). On the other hand, if the host computer determines that there is a loop within the code (203, Yes), the host computer may further read loop count M (204). Loop count M may indicate how many times the loop repeats, and every repeat may increase the actual execution length of the code.

Further, the host computer may read in the available loop count N for the particular or current segment (205). An available loop count N may indicate a desired or maximum number of loop count that the current code segment can contain (e.g., length-wise). After obtaining the available loop count N (205), the host computer may determine whether M is greater than N (206). If the host computer determines that M is not greater than N (206, No), the host computer may process the code segment normally (209). On the other hand, if the host computer determines that M is greater than N (206, Yes), the host computer may separate the loop into two sub-loops (207). One sub-loop has a loop count of N, and the other sub-loop has a loop count of M-N. Further, the original M is set as M-N (i.e., the other sub-loop) for the next code segment (208) and return to 205 to further determine whether M-N is within the available loop count of the next code segment. This process repeats until all loop counts are less than the available loop count N of the code segment.

Returning to FIG. 1, similar to the segment information, allocation information (e.g., which code segment is allocated to which processor core 301) may also be determined based on the operation model 108 or based on predetermined structural information 106. Segment information and allocation information may be a part of the configuration information needed to configure the interconnected processor cores 301 and to facilitate the operation of the interconnected processor cores 301.

Therefore, the executable code segments and configuration information 110 are generated and guiding code segments 109 may also be generated corresponding to the executable code segments. A guiding code segment 109 may include a certain amount of code to set up a corresponding executable code segment in a particular processor core 301, e.g., certain setup code at the beginning and the end of the code segment, as explained in later sections.

It is understood that the pre-compiling processing 103 is performed before compiling the source code, performed by a compiler as part of the compiling process on the source code, or performed in real-time by an operating system of the multi-core processor, a driver, or an application program during operation of the serially-interconnected processor cores 301 or the multi-core processor 300. Also, the post-compiling 107 is performed after compiling the source code, performed by a compiler as part of the compiling process on the source code, or performed in real-time by an operating system of the multi-core processor, a driver, or an application program during operation of the serially-interconnected processor cores 301 or the multi-core processor 300.

After the executable code segment configuration information 110 and corresponding guiding code segments 109 are generated, the code segments may be allocated to the plurality of processor cores 301 (e.g., processor core 111 and processor core 113). DMA 112 may be used to transfer code segments as well as any shared data among the plurality of processor cores 301.

Because the code segments are executed by different processor cores 301 in a pipelined manner, each code segment may include additional code (i.e., guiding code) to facilitate the pipelined operation of multiple processor cores 301. For example, the additional code may include certain extension at the beginning of the code segment and at the end of the code segment to achieve a smooth transition between the instruction executions in different processor cores. For example, the code segment may be added an extension at the end to store all values of the register file in a specific location of the data memory. The code segment may also be added an extension at the beginning to read the stored values from the specific location of the data memory to the register file such that values of the register files of different processor cores can be passed from one another to ensure correct code execution. After a processor core 301 executes the end of the corresponding code segment, processor core 301 may execute from the beginning of the same code segment. Or processor core 301 may execute from beginning of a different code segment, depending on particular applications and configurations.

Each segment allocated to a particular processor core 301 may be defined by certain segment information, such as the number of instructions, specific indicators of segment boundaries, and a listing table of starting information of the code segment, etc. In addition, the code segments may be executed by the plurality of processor cores 301 in a pipeline manner. That is, the plurality of processor cores 301 are executing simultaneously the code segments on data from different stages of pipeline.

For example, if the multi-core processor 300 includes 1000 processor cores, a table with 1000 entries may be created based on the maximum number of processor cores. Each entry includes position information of the corresponding code segment, i.e., the position of the code segment in the original un-segmented code stream. The position may be a starting position or an end position, and the code segment between two positions is the code segment for the particular processor core. If all of the 1000 processor cores are operating, each processor core is thus configured to execute a code segment between the two positions of the code stream. If only N number of processor cores are operating (N<1000), each of the N processor cores is configured to execute the corresponding 1000/N code segments as determined by the corresponding position information in the table.

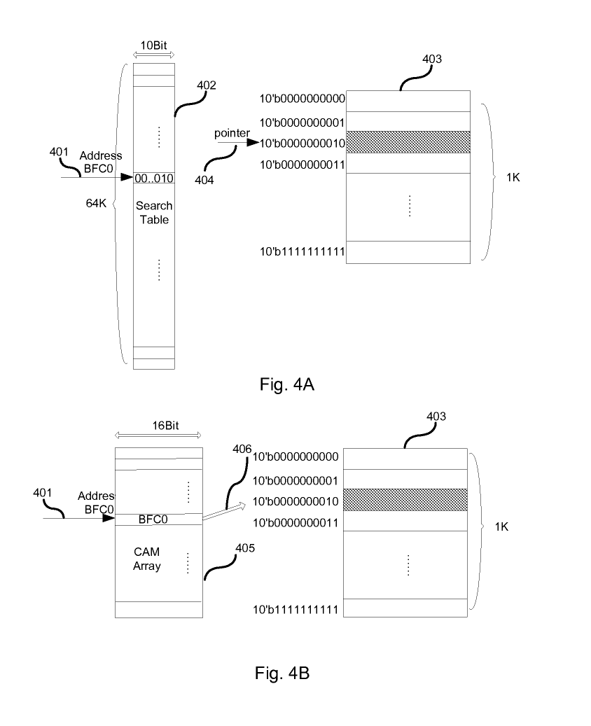

FIGS. 4A and 4B illustrate exemplary address mapping to determine code segment addresses. As shown in FIG. 4A, a lookup table 402 is used to achieve address lookup. Using 16-bit addressing as an example, a 64K address space is divided into multiple 1K address spaces of small memory blocks 403. Other address space and different sizes of small memory may also be used. The multiple small memory blocks 403 may be used to write data such as code segments and other data, and the memory blocks 403 are written in a sequential order. For example, after a write operation on one memory block is completed, the valid bit of the memory block is set to ‘1’, and the pointer of memory 403 automatically points to a next available memory block (the valid bit is ‘0’). The next available memory block is thus used for a next write operation. Thus, each memory block may include both data and flag information. The flag information may include a valid bit and address information to be used to indicate a position of the code segment in the original code stream.

When data is written into each memory block, the associated address is also written into the lookup table 402. If a write address BFC0 is used as an example, when the address pointer 404 points to the No. 2 block of memory 403, data is written into the No. 2 block, and the No. 2 is also written into an entry of lookup table 402 corresponding to the address of BFC0. A mapping relationship is therefore established between the No. 2 memory block and the lookup table entry. When reading the data, the lookup table entry can be found based on the address (e.g., BFC0), and the data in the memory block (e.g., No. 2 block) can then be read out.

Further, as shown in FIG. 4B, a content addressable memory (CAM) array may be used to achieve the address lookup. Similar to FIG. 4A, using 16-bit addressing as an example, a 64K address space is divided into multiple 1K address spaces of small memory blocks 403. The multiple small memory blocks 403 may be written in a sequential order. After write to one memory block is completed, the valid bit of the memory block is set to ‘1’, and the pointer of memory blocks 403 automatically points to a next available memory block (the valid bit is ‘0’). The next available memory block is then used for a next write operation.

When data is written into each memory block, the associated address is also written into a next table entry of the CAM array 405. If a write address BFC0 is used as an example, when the address pointer 406 points to the No. 2 block of memory 403, data is written into the No. 2 block, and the address BFC0 is also written into the next entry of CAM array 405 to establish a mapping relationship. When reading the data, the CAM array is matched with the instruction address to find the table entry (e.g., the BFC0 entry), and the data in the memory block (e.g., No. 2 block) can then be read out.

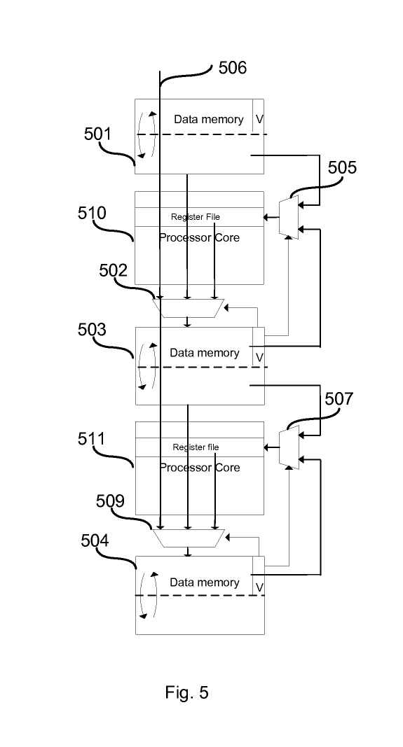

FIG. 5 illustrates an exemplary data exchange among processor cores. As shown in FIG. 5, all data memory 501, 503, and 504 are located between processor cores 510 and 511 and each data memory 501, 503, or 504 is logically divided into an upper part and a lower part. The upper part is used by a processor core above the data memory to read and write data from and to the data memory; while the lower part is used by a processor core below the data memory to read and write data from and to the data memory. At the same time a processor core is executing the program, data from data memory are relayed from one data memory down to another data memory.

For example, 3-to-1 selectors 502 and 509 may select external or remote data 506 into data memory 503 and 504. When processor cores 510 and 511 do not execute a ‘store’ instruction, lower parts of data memory 501 and 503 may respectively write data into upper parts of data memory 503 and 504 through 3-to-1 selectors 502 and 509. At the same time, a valid bit V of the written row of the data memory is also set to ‘1’. When a processor core is executing the ‘store’ instruction, the corresponding register file only writes data into the data memory below the processor core. For example, processor core 510 may only store data into data memory 503. When a processor core 510 or 511 is executing a ‘load’ instruction, 2-to-1 selector 505 or 507 may be controlled by the valid bit V of data memory 503 or 504 to choose data from data memory 501 or 503 or from data memory 503 or 504, respectively. If the valid bit V of the data memory 503 or 504 is ‘1’, indicating the data is updated from the above data memory 501 or 503, and when the external data 506 is not selected, 3-to-1 selector 502 or 509 may select output of the register file from processor core 510 or 511 as input, to ensure stored data is the latest data processed by processor core 510 or 511. When the upper part of data memory 503 is written with data, data in the lower part of data memory 503 may be transferred to the upper part of the data memory 504.

During data transfer, a pointer is used to indicate the entry or row being transferred into. When the pointer points to the last entry, the transfer is about to complete. During the execution of a portion of program, the data transfer from one data memory to a next data memory should have completed. Then, during the execution of a next portion of program, data is transferred from the upper part of the data memory 501 to the lower part of the data memory 503, and from the upper part of the data memory 503 to the lower part of the data memory 504. Data from the upper part of the data memory 504 can also be transferred downward to form a ping-pong transfer structure. The data memory may also be divided to have a portion being used to store instructions. That is, data memory and instruction memory may be physically inseparable.

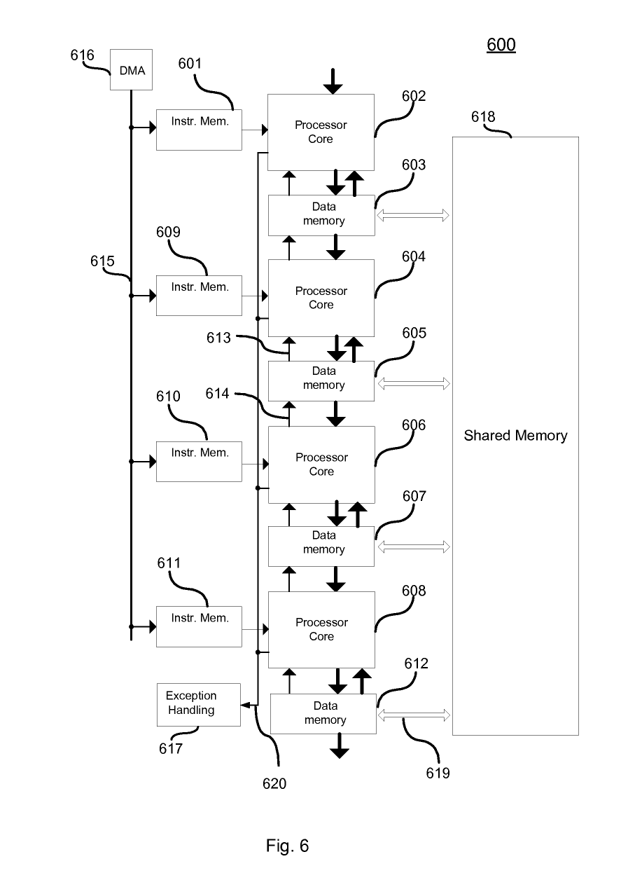

FIG. 6 illustrates another exemplary configuration of a multi-core structure 600. As shown in FIG. 6, multi-core structure 600 includes a plurality of instruction memory 601, 609, 610, and 611, a plurality of data memory 603, 605, 607, and 612, and a plurality of processor cores 602, 604, 606, and 608. A shared memory 618 is included for data sharing among various devices including the processor cores. A DMA controller 616 is coupled to the instruction memory 601, 609, 610, and 611 to write corresponding code segments 615 into the instruction memory 601, 609, 610, and 611 to be executed by processor cores 602, 604, 606, and 608, respectively. Further, processor cores 602, 604, 606, and 608 are coupled to data memory 603, 605, 607, and 612 for read and write operations.

Each of data memory 603, 605, 607, and 612 may include an upper part and a lower part, as mentioned above. The processor core 604 and the processor core 606 are two stages in the macro pipeline of the multi-core structure 600, where the processor core 604 may be referred to as a previous stage of the macro pipeline and the processor core 606 may be referred to as a current stage. Both processor core 604 and the processor core 606 can read and write from and to the data memory 605, which is coupled between the processor core 604 and the processor core 606. However, only after the processor core 604 completed writing data into data memory 605 and the processor core 606 completed reading data from the data memory 605, the upper part and the lower part of data memory 605 can perform the ping-pong data exchange.

Further, back pressure signal 614 is used by a processor core (e.g., processor core 606) to inform the data memory at the previous stage (e.g., data memory 605) whether the processor core has completed read operation. Back pressure signal 613 is used by a data memory (e.g., data memory 605) to notify the process core at the previous stage (e.g., processor core 604) whether there is a memory overflow and to pass the back pressure signal 614 from a processor core at a current stage (e.g., processor core 606). The processor core at the previous stage (e.g., processor core 604), according to its operation condition and the back pressure signal from the corresponding data memory (e.g., data memory 605), may determine whether the macro pipeline is blocked or stalled and whether to perform a ping-pong data exchange with respect to the corresponding data memory (e.g., data memory 605) and may further generate a back pressure signal and pass the back pressure signal to its previous stage. For example, after receiving a back pressure signal from a next stage processor core, a processor core may stop sending data to the next stage processor core. The processor core may further determine whether there is enough storage for storing data from a previous stage processor core. If there is not enough storage for storing data from the previous stage processor core, the processor may generate and send a back pressure signal to the previous stage processor core to indicate congestion or blockage of the pipeline. Thus, by passing the back pressure signals from one processor core to the data memory and then to another processor core in a reverse direction, the operation of the macro pipeline may be controlled.

In addition, all data memory 603, 605, 607, and 612 are coupled to shared memory 618 through connections 619. When a read address or a write address used to access a data memory is out of the address range of the data memory, an addressing exception occurs and the shared memory 618 is accessed to find the address and its corresponding memory and the data can then be written into that address or read from that address. Further, when the processor core 608 needs to access the data memory 605 (i.e., data access to memory of an out-of-order pipeline stage), an exception also occurs, and the data memory 605 pass the data to the processor core 608 through shared memory 618. The exception information from both the data memory and the processor cores are transferred to an exception handling module 617 through a dedicated channel 620.

After receiving the exception information, exception handling module 617 may perform certain actions to handle the exception. For example, if there is an overflow in a processor core, exception handling module 617 may control the processor core to perform a saturation operation on the overflow result. If there is an overflow in a data memory, exception handling module 617 may control the data memory to access shared memory 618 to store the overflowed data in the shared memory 618. During the exception handling, exception handling module 617 may signal the involving processor core or data memory to block operation of the involving processor core or data memory, and to restore operation after the completion of exception handling. Other processor cores and data memory may determine whether to block operation based on the back pressure signal received.

As previously explained, processor cores need to perform read/write operations during multi-core operation. The disclosed multi-core structure (e.g., multi-core structure 600) or multi-core processor may include a read policy (i.e., specific rules for reading) and a write policy (i.e., specific rules for writing).

More particularly, the reading rules may define sources for data input to a processor core. For example, the sources for data input to a first stage processor core in the macro pipeline may include the corresponding configurable data memory, shared memory, and external devices. Sources for data input to other stages of processor cores in the macro pipeline may include the corresponding configurable data memory, configurable data memory from a previous stage processor core, shared memory, and external devices. Other sources may also be included.

The writing rules may define destinations for data output from a processor core. For example, the destinations for data output from the first stage processor core in the macro pipeline may include the corresponding configurable data memory, shared memory, and external devices. Destinations for data output from other stages of processor cores in the macro pipeline may include the corresponding configurable data memory, shared memory, and external devices. Other destinations may also be included. That is, the write operations of the processor cores always going forward.

Thus, a configurable data memory can be accessed by processor cores at two stages of the macro pipeline, and different processor cores can access different sub-modules of the configurable data memory. Such access may be facilitated by a specific rule to define different accesses by the different processor cores. For example, the specific rule may define the sub-modules of the configurable data memory as ping-pong buffers, where the sub-modules are visited by two different processor cores and after the processor cores completed the accessed, a ping-pong buffer exchange is performed to mark the sub-module accessed by the previous stage processor core as the sub-module to be accessed by the current stage processor core, and to mark the sub-module accessed by the current stage processor core as invalid such that the previous stage processor core can access.

Further, when each processor core includes a register file, a specific rule may be defined to transfer values of registers in the register file between two related processor cores. That is, values of any one or more registers of a processor core can be transferred to corresponding one or more registers of any other processor core. These values may be transferred by any appropriate methods.

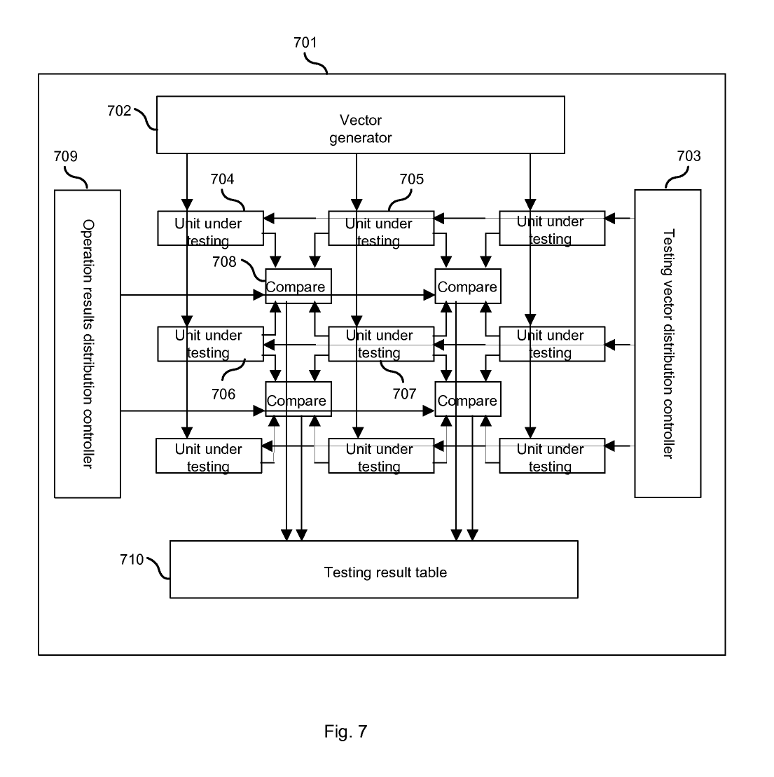

Further, the disclosed serial multi-issue and macro pipeline structure can be configured to have a power-on self-test capability without relying on external testing equipment. FIG. 7 illustrates an exemplary multi-core self-testing and self-repairing system 701. As shown in FIG. 7, system 701 may include a vector generator 702, a testing vector distribution controller 703, a plurality of units under testing (e.g., unit under testing 704, unit under testing 705, unit under testing 706, and unit under testing 707), a plurality of compare logic 708, an operation results distribution controller 709, and a testing result table 710. Certain devices may be omitted and other devices may be included.

Vector generator 702 may generate testing vectors to be used for the plurality of units (processor cores) and also transfer the testing vectors to each processor core in synchronization. Testing vector distribution controller 703 may control the connections among the processor cores and the vector generator 702, and operation results distribution controller 709 controls the connection among the processor cores and the compare logic 708. A processor core can compare its own results with results of other processor cores through the compare logic 708. Compare logic 708 may be formed using a basic logic device, an execution unit, or a processor core from system 701.

In certain embodiments, each processor core can compare results with neighboring processor cores. For example, processor core 704 can compare results with processor cores 705, 706, and 707 through compare logic 708. The results may include any output from any operation of any device, such as basic logic device, an execution unit, or a processor core. The comparison may determine whether the outputs satisfy a particular relationship, such as equal, opposite, reciprocal, and complementary. The outputs/results may be stored in memory of the processor cores or may be transferred outside the processor cores. Further, the compare logic 708 may include one or more comparators. If the compare logic 708 includes one comparator, each processor core in turn compares results with neighboring processor cores. If the compare logic 708 includes multiple comparators, a processor core can compare results with other processor cores at the same time. The testing results can be directly written into testing result table 710 by compare logic 708. Based on the testing results or comparison results, a processor core may determine whether its operation results satisfy certain criteria (e.g., matching with other processor cores' results) and may further determine whether there is any fault within the system.

Such self-testing may be performed during wafer testing, integrated circuit testing after packaging, or multi-core chip testing during power-on. The self-testing can also be performed under various pre-configured testing conditions and testing periods, and periodical self-testing can be performed during operation. Memory used in the self-testing includes, for example, volatile memory and non-volatile memory.

Further, system 701 may also have self-repairing capabilities. Any mal-function processor core is marked as invalid when the testing results are stored in the memory, indicating any fault. When configuring the processor cores, the processor core or cores marked as invalid may be bypassed such that the multi-core system 701 can still operate normally to achieve self-repairing. Similarly, such self-repairing may be performed during wafer testing, integrated circuit testing after packaging, or multi-core chip testing during power-on. The self-repairing can also be performed under various pre-configured testing/self-repairing conditions and periods, and after periodical self-testing during operation.

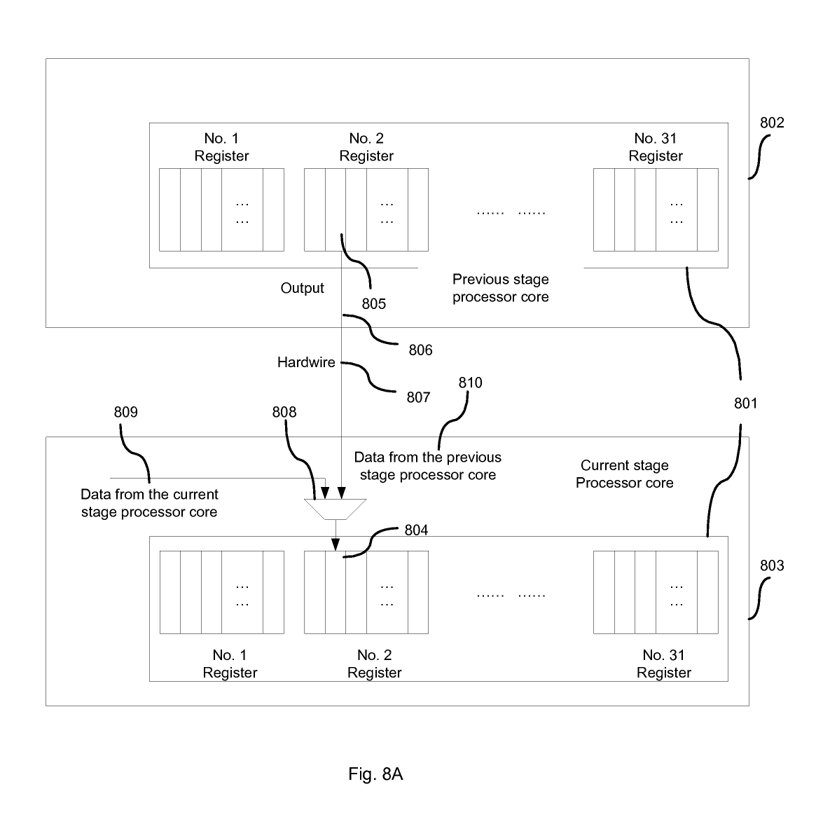

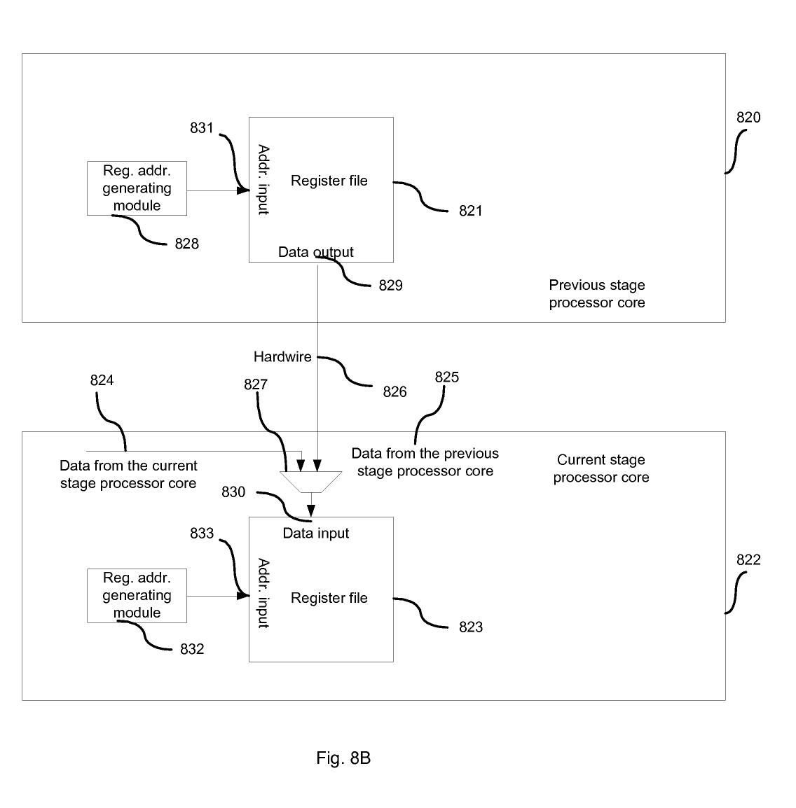

As previously explained, the processor cores at different stages of the macro pipeline may need to transfer values of the register file to one another. FIG. 8A illustrates an exemplary register value exchange between processor cores consistent with the disclosed embodiments.

As shown in FIG. 8A, previous stage processor core 802 and current stage processor core 803 are coupled together as two stages of the macro pipeline. Each processor core contains a register file 801 having thirty-one (31) 32-bit general purpose registers, a total of 31×32=992 bits. Any number of registers of any width may be used.

Values of register file 801 of previous stage processor core 802 can be transferred to register file 801 of current stage processor core 803 through hardwire 807, which may include 992 lines, each line representing a single bit of registers of register file 801. More particularly, each bit of registers of previous stage processor core 802 corresponds to a bit of registers of current stage processor core 803 through a multiplexer (e.g., multiplexer 808). When transferring the register values, values of the entire 31 32-bit registers can be transferred from the previous stage processor core 802 to the current stage processor core 803 in one cycle.

For example, a single bit 804 of No. 2 register of current stage processor core 803 is hardwired to output 806 of the corresponding single bit 805 in No. 2 register of previous stage processor core 802. Other bits can be connected similarly. When the current stage processor core 803 performs arithmetic, logic, and other operations, the multiplexer 808 selects data from the current stage processor core 809; when the current processor core 803 performs a loading operation, if the data exists in the local memory associated with the current stage processor core 803, the multiplexer 808 selects data from the current stage processor core 809, otherwise the multiplexer 808 selects data from the previous stage processor core 810. Further, when transferring register values, the multiplexer 808 selects data from the previous stage processor core 810 and all 992 bits of the register file can be transferred in a single cycle.

It is understood that the register file or any particular register is used for illustrative purposes, any form of processor status information contained in any device may be exchanged between different stages of processor cores or may be transferred from a previous stage processor core to a current stage processor core or from a current stage processor core to a next stage processor core. In practice, certain processor cores or all processor cores may or may not have a register file, and processor status information in other devices in processor cores may be similarly processed.

FIG. 8B illustrates another exemplary register value exchange between processor cores consistent with the disclosed embodiments. As shown in FIG. 8B, previous stage processor core 820 and current stage processor core 822 are coupled together as two stages of the macro pipeline. Each processor core contains a register file having thirty-one (31) 32-bit general purpose registers. Any number of registers of any width may be used.

Previous stage processor core 820 includes a register file 821 and current stage processor core 822 includes a register file 823. Hardwire 826 may be used to transfer values of register file 821 to register file 823. Different from FIG. 8A, hardwire 826 may only include 32 lines to connect output 829 of register file 821 to input 830 of register file 823 through multiplexer 827. Inputs to the multiplexer 827 are data from the current stage processor core 824 and data from the previous stage processor core 825. When the current stage processor core 822 performs arithmetic, logic, and other operations, the multiplexer 827 selects data from the current stage processor core 824; when the current processor core 822 performs a loading operation, if the data exists in the local memory associated with the current stage processor core 822, the multiplexer 827 selects data from the current stage processor core 824, otherwise the multiplexer 827 selects data from the previous stage processor core 825. Further, when transferring register values, the multiplexer 827 selects data from the previous stage processor core 825.

Further, register address generating module 828 generates a register address (i.e., which register from the register file 821) for register value transfer and provides the register address to address input 831 of register file 821, and register address generating module 832 also generates a corresponding register address for register value transfer and provides the register address to address input 833 of register file 823. Thus, values of 32 bits of a single register can be transferred from register file 821 to register file 823 at one cycle, through hardwire 826 and multiplexer 827. Therefore, values of all registers in the register file can be transferred in multiple cycles using a substantially small number of lines in hardwire 826.

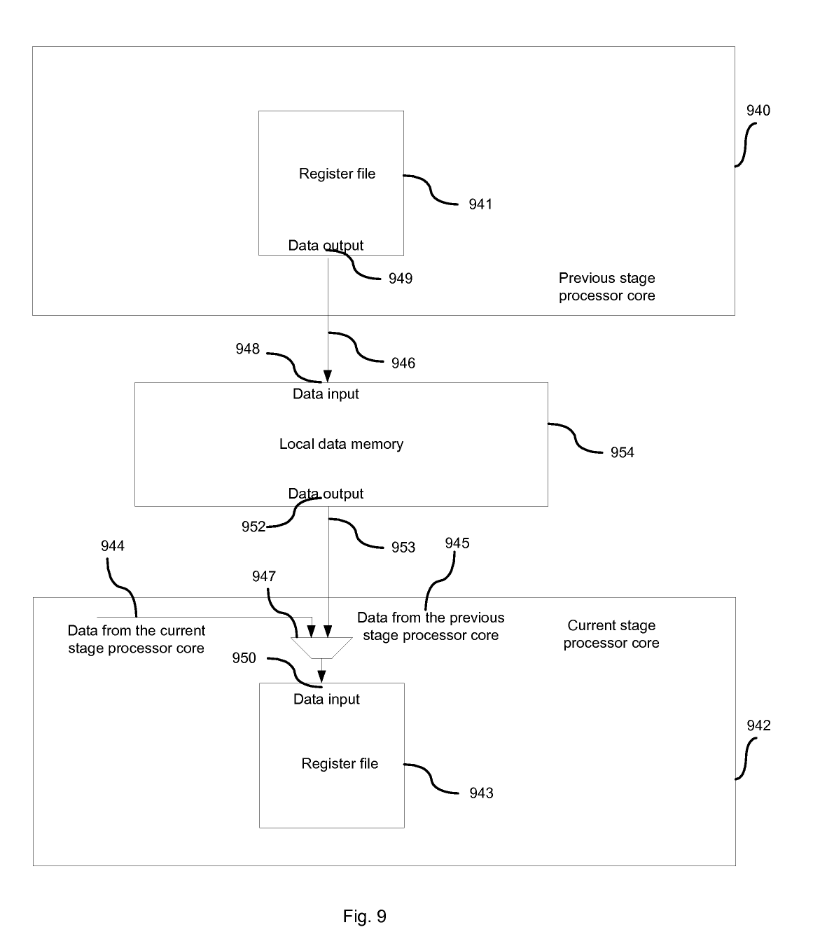

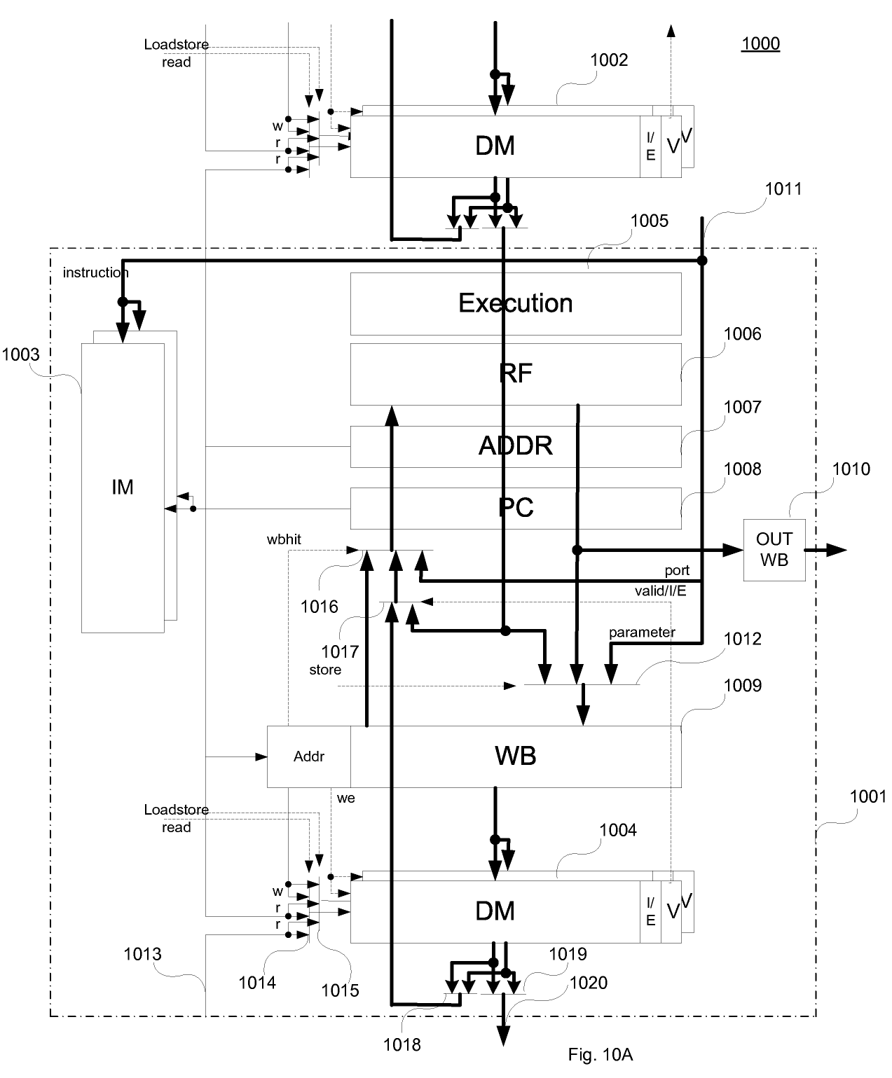

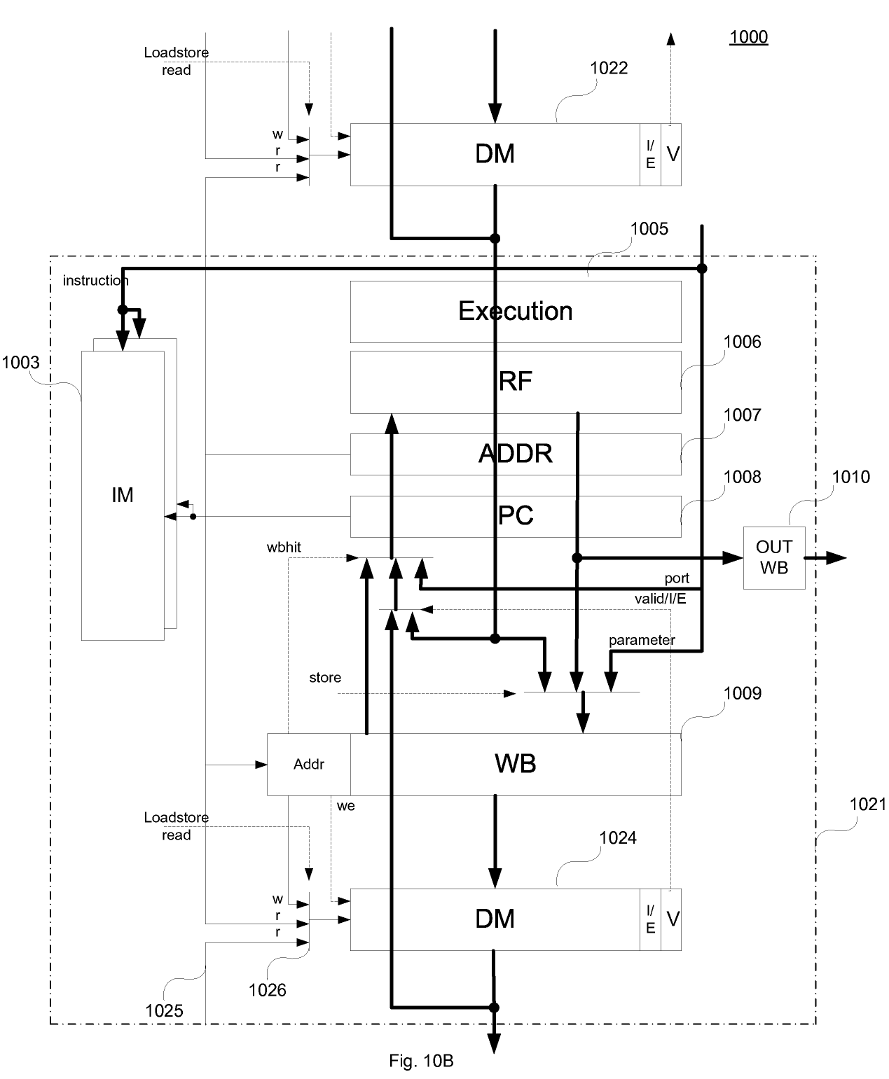

FIG. 9 illustrates another exemplary register value exchange between processor cores consistent with the disclosed embodiments. As shown in FIG. 9, previous stage processor core 940 and current stage processor core 942 are coupled together as two stages of the macro pipeline. Each processor core contains a register file having thirty-one (31) 32-bit general purpose registers. Any number of registers of any width may be used.

Previous stage processor core 940 includes a register file 941 and current stage processor core 942 includes a register file 943. When transferring register values from previous stage processor core 940 to current stage processor core 942, previous stage processor core 940 may use a ‘store’ instruction to write the value of a register from register file 941 in a corresponding local data memory 954. The current stage processor core 942 may then use a ‘load’ instruction to read the register value from the local data memory 954 and write the register value to a corresponding register in register file 943.

Further, data output 949 of register file 941 may be coupled to data input 948 of the local data memory 954 through a 32-bit connection 946, and data input 950 of register file 943 may be coupled to data output 952 of data memory 954 through a 32-bit connection 953 and the multiplexer 947.

Inputs to the multiplexer 947 are data from the current stage processor core 944 and data from the previous stage processor core 945. When the current stage processor core 942 performs arithmetic, logic, and other operations, the multiplexer 947 selects data from the current stage processor core 944; when the current processor core 942 performs a loading operation, if the data exists in the local memory associated with the current stage processor core 942, the multiplexer 947 selects data from the current stage processor core 944, otherwise the multiplexer 947 selects data from the previous stage processor core 945. Further, when transferring register values, the multiplexer 947 selects data from the previous stage processor core 945.

Further, previous stage processor core 940 may write the values of all registers of register file 941 in the local data memory 954, and current stage processor core 942 may then read the values and write the values to the registers in register file 943 in sequence. Previous stage processor core 940 may also write the values of some registers but not all of register file 941 in the local data memory 954, and current stage processor core 942 may then read the values and write the values to the corresponding registers in register file 943 in sequence. Alternatively, previous stage processor core 940 may write the value of a single register of register file 941 in the local data memory 954, and current stage processor core 942 may then read the value and write the value to a corresponding register in register file 943, and the process is repeated until values of all registers in the register file 941 are transferred.

In addition, a register read/write record may be used to determine particular registers whose values need to be transferred. The register read/write record is used to record the read/write status of a register with respect to the local data memory. If the values of the register were already written into the local data memory and the values of the register have not been changed since the last write operation, a next stage processor core can read corresponding data from the data memory of the current stage to complete the register value transfer, without the need to separately transfer register values to the next stage processor core (e.g., the write operation).

For example, when the register value is written to the appropriate local data memory, a corresponding entry in the register read/write record is set to “0”, when the corresponding data is written into the register (e.g., data in the local data memory or execution results), the corresponding entry in the register read/write record to “1.” When transferring register values, only values of registers with “1” in the entry in the register read/write record need to be transferred.

As previously explained, guiding codes are added to a code segment allocated to a particular processor core. These guiding codes can also be used to transfer values of the register files. For example, a header guiding code is added to the beginning of the code segment to write values of all registers into the registers from memory at a certain address, and an end guiding code is added to the end of the code segment to store values of all registers into memory at a certain address. The values of all registers may then be transferred seamlessly.

Further, when the code segment is determined, the code segment may be analyzed to optimize or reduce the instructions in the guiding codes related to the registers. For example, within the code segment, if a value of a particular register is not used before a new value is written into the particular register, the instruction storing value of the particular register in the guiding code of the code segment for the previous stage processor core and the instruction loading value of the particular register in the guiding code of the code segment for the current stage processor core can be omitted.

Similarly, if the value of a particular register stored in the local data memory has not been changed during the entire code segment for the previous stage processor core, the instruction storing value of the particular register in the guiding code of the code segment for the previous stage processor core can be omitted, and the guiding code of the code segment for the current stage processor core may be modified to load the value of the particular register from the local data memory.

In the present disclosure, a processor core is configured to be associated with a local memory to form a stage of the macro pipeline. Various configurations and data accessing mechanisms may be used to facilitate the data flow in the macro pipeline. FIGS. 10A-10C illustrate exemplary configurations of processor core and local data memory consistent with the disclosed embodiments.

As shown in FIG. 10A, multi-core structure 1000 includes a processor core 1001 having local instruction memory 1003 and local data memory 1004, and local data memory 1002 associated with a previous stage processor core (not shown). Processor core 1001 includes local instruction memory 1003, local data memory 1004, an execution unit 1005, a register file 1006, a data address generation module 1007, a program counter (PC) 1008, a write buffer 1009, and an output buffer 1010. Other components may also be included.

Local instruction memory 1003 may store instructions for the processor core 1001. Operands needed by the execution unit 1005 of processor core 1001 are from the register file 1006 or from immediate in the instructions. Results of operations are written back to the register file 1006. Further, local data memory may include two sub-modules. For example, local data memory 1004 may include two sub-modules. Data read from the two sub-modules are selected by multiplexers 1018 and 1019 to produce a final data output 1020.

Processor core 1001 may use a ‘load’ instruction to load register file 1006 with data in the local data memory 1002 and 1004, data in write buffer 1009, or external data 1011 from shared memory (not shown). For example, data in the local data memory 1002 and 1004, data in write buffer 1009, and external data 1011 are selected by multiplexers 1016 and 1017 into the register file 1006.

Further, processor core 1001 may use a ‘store’ instruction to write data in the register file 1006 into local data memory 1004 through the write buffer 1009, or to write data in the register file 1006 into external shared memory through the output buffer 1010. Such write operation may be a delay write operation. Further, when data is loaded from local data memory 1002 into the register file 1006, the data from local data memory 1002 can also be written into local data memory 1004 through the write buffer 1009 to achieve so-called load-induced-store (LIS) capability and to realize no-cost data transfer.

Write buffer 1009 may receive data from three sources: data from the register file 1006, data from local data memory 1002 of the previous stage processor core, and data 1011 from external shared memory. Data from the register file 1006, data from local data memory 1002 of the previous stage processor core, and data 1011 from external shared memory are selected by multiplexer 1012 into the write buffer 1009. Further, local data memory may only accept data from a write buffer within the same processor core. For example, in processor core 1001, local data memory 1004 may only accept data from the write buffer 1009.

In certain embodiments, the local instruction memory 1003 and the local data memory 1002 and 1004 each includes two identical memory sub-modules, which can be written or read separately at the same time. Such structure can be used to implement so-called ping-pong exchange within the local memory. Further, addresses to access local instruction memory 1003 are generated by the program counter (PC) 1008. Addresses to access local data memory 1004 can be from three sources: addresses from the write buffer 1009 in the same processor core (e.g., in an address storage section of write buffer 1009 storing address data), addresses generated by data address generation module 1007 in the same processor core, and addresses 1013 generated by a data address generation module in a next stage processor core. The addresses from the write buffer 1009 in the same processor core, the addresses generated by data address generation module 1007 in the same processor core, and the addresses 1013 generated by the data address generation module in the next stage processor core are further selected by multiplexer 1014 and 1015 into address ports of the two sub-modules of local data memory 1004 respectively.

Similarly, addresses to access the local data memory 1002 can also be from three sources: addresses from an address storage section of a write buffer (not shown) in the same processor core, addresses generated by a data address generation module in the same processor core, and addresses generated by the data address generation module 1007 in processor core 1001 (i.e., the next stage processor core with respect to data memory 1002). These addresses are selected by two multiplexers into address ports of the two sub-modules of local data memory 1002 respectively.

Thus, the two sub-modules of local data memory 1009 may be used separately for read operation and write operation. That is, processor core 1001 may write data to be used for the next stage processor core in one sub-module (‘write’ sub-module), while the next stage processor core reads data from the other sub-module (‘read’ sub-module). Upon certain conditions (e.g., a pipeline parameter, or determined by processor cores), the contents of the two sub-modules exchanged or flipped such that the next stage processor core can continue reading from the ‘read’ sub-module, and the processor core 1001 may continue writing data to the ‘write’ sub-module.

As shown in FIG. 10B, multi-core structure 1000 includes a processor core 1021 having local instruction memory 1003 and local data memory 1024, and local data memory 1022 associated with a previous stage processor core (not shown). Similar to processor core 1001 in FIG. 10A, processor core 1021 includes local instruction memory 1003, local data memory 1024, execution unit 1005, register file 1006, data address generation module 1007, program counter (PC) 1008, write buffer 1009, and output buffer 1010.

However, different from FIG. 10A, local data memory 1022 and 1024 include a single dual-port memory module instead of two sub-modules. The dual-port memory module can support read and write operations using two different addresses.

Addresses to access local data memory 1024 can be from three sources: addresses from the address storage section of the write buffer 1009 in the same processor core, addresses generated by data address generation module 1007 in the same processor core, and addresses 1025 generated by a data address generation module in a next stage processor core. The addresses from the write buffer 1009 in the same processor core, the addresses generated by data address generation module 1007 in the same processor core, and the addresses 1025 generated by the data address generation module in the next stage processor core are further selected by a multiplexer 1026 into an address port of the local data memory 1024.

Similarly, addresses to access local data memory 1022 can also be from three sources: addresses from an address storage section of a write buffer (not shown) in the same processor core, addresses generated by a data address generation module in the same processor core, and addresses generated by data address generation module 1007 (i.e., in a current stage processor core). These addresses are selected by a multiplexer into an address port of the local data memory 1022.

Alternatively, because ‘load’ instructions and ‘store’ instructions generally count less than forty percent of a computer program, a single-port memory module may be used to replace the dual-port memory module. When a single-port memory module is used, the sequence of instructions in the computer program may be statically adjusted during compiling or may be dynamically adjusted during program execution such that instructions requiring access to the memory module can be executed at the same time when executing instructions not requiring access to the memory module.

Further, similar to data memory, instruction memory 1003 may also be configured to have one or more sub-modules and the one or more sub-modules may have one or more read/write ports. When a processor core is fetching instructions from the instruction memory 1003 from one sub-module, other sub-modules may perform instruction updating operations.

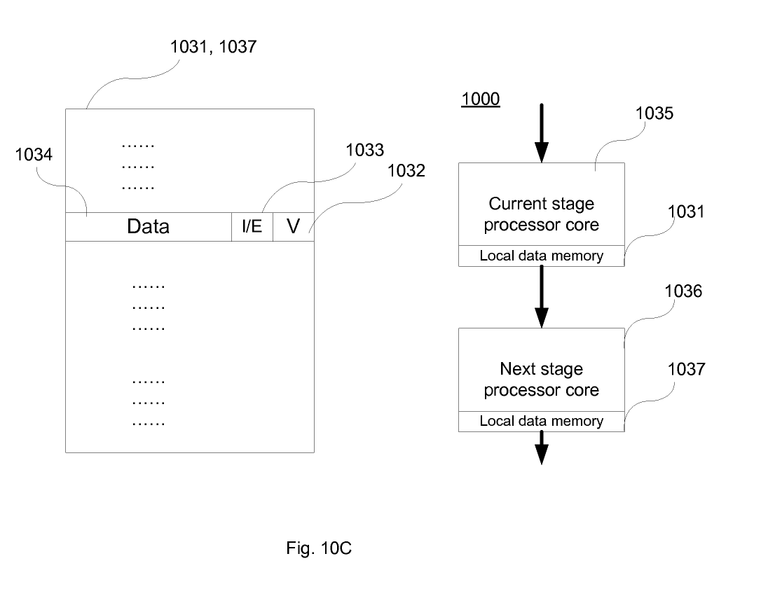

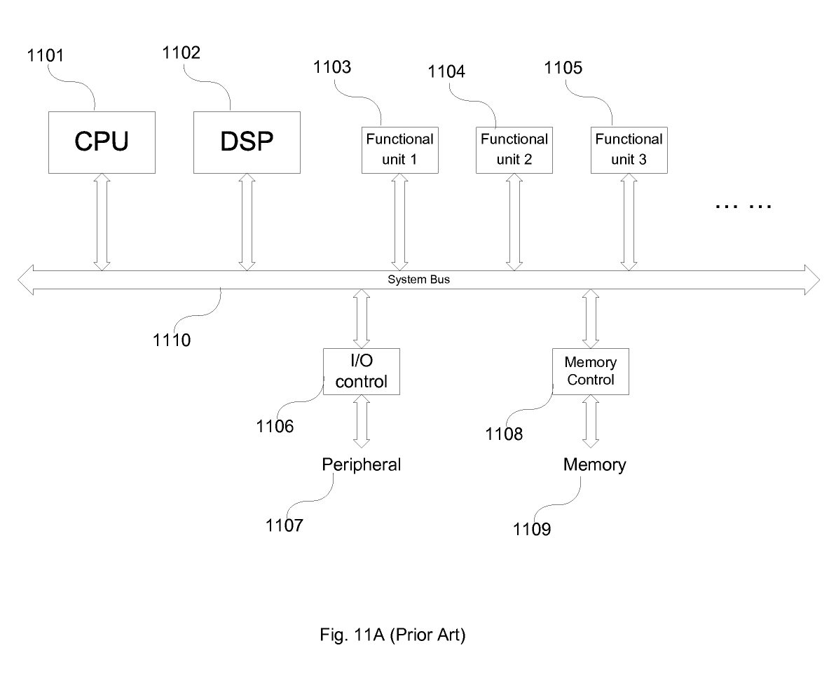

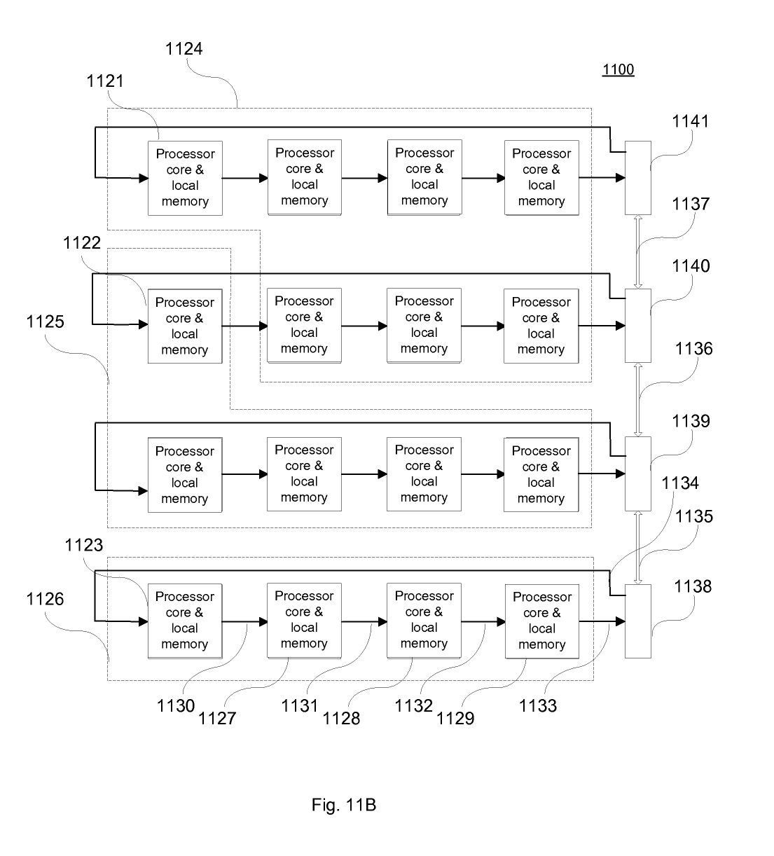

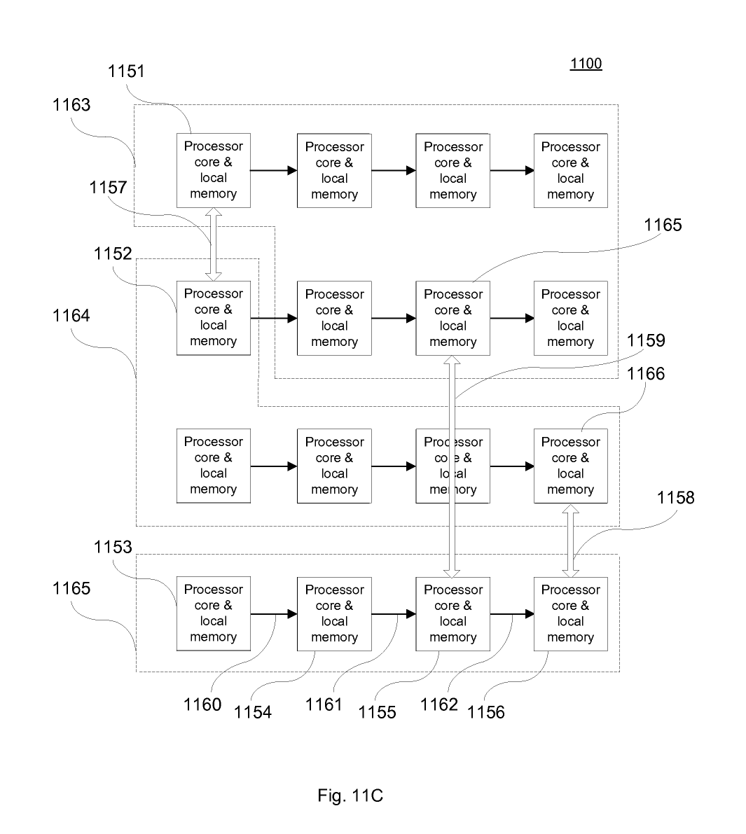

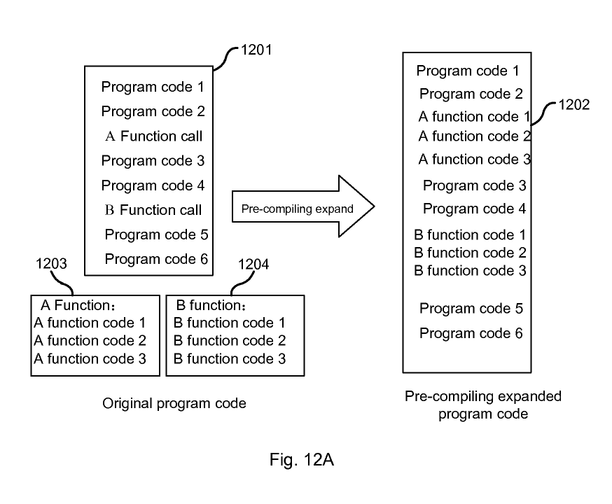

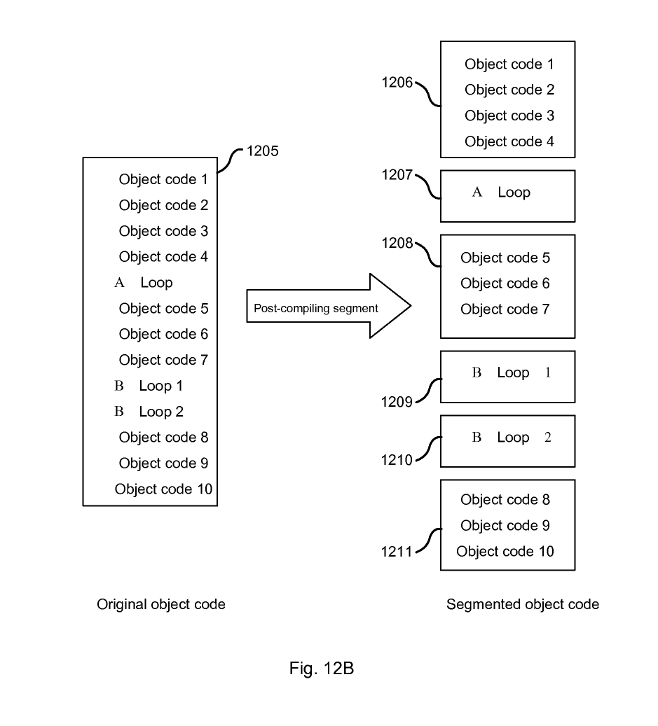

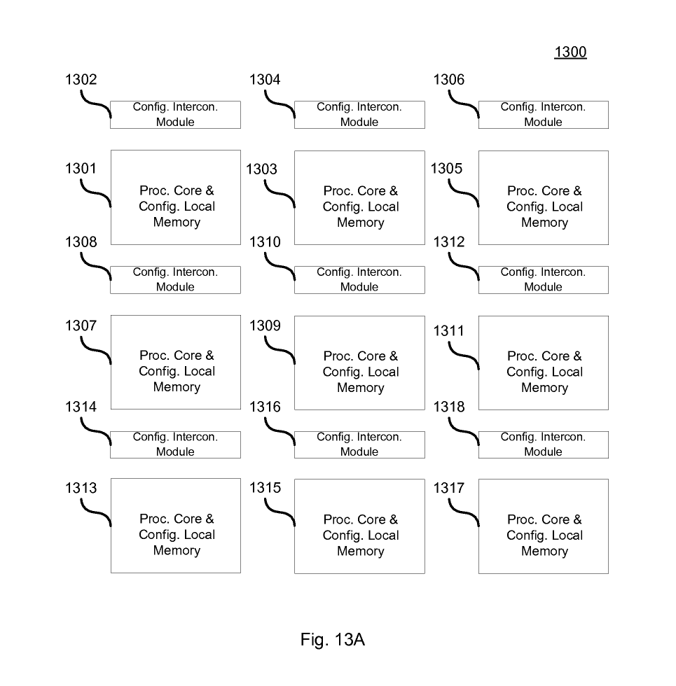

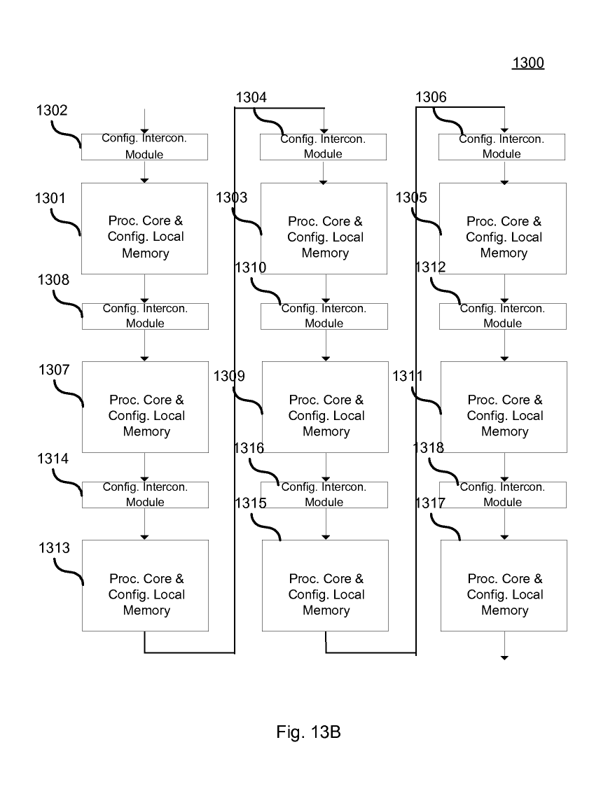

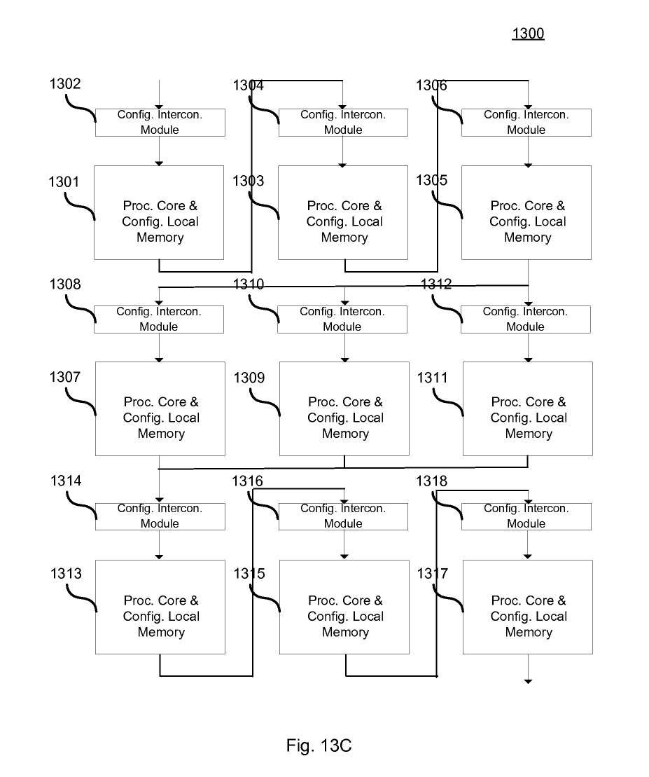

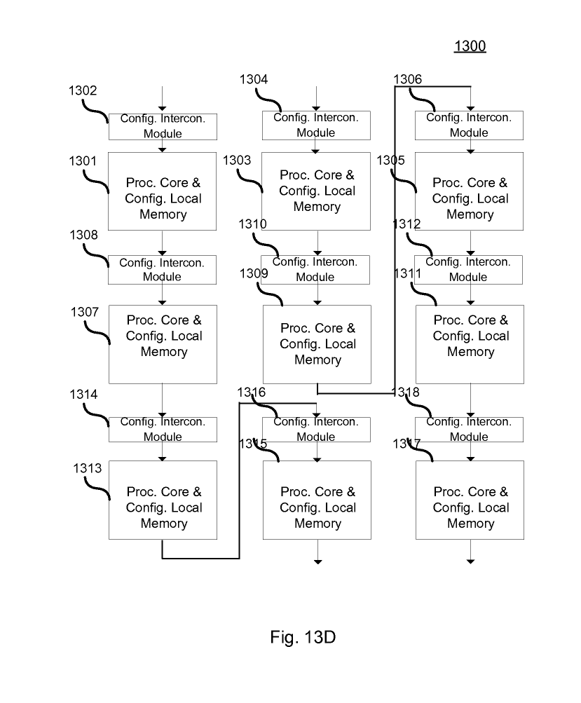

Because only one module/sub-module may be used, to ensure that the data to be read by next stage processor core is not over-written by current stage processor core by mistake, certain techniques in FIG. 100 may be used. FIG. 100 illustrates an exemplary configuration of a memory module used in multi-core structure 1000. As shown in FIG. 100, multi-core structure 1000 includes a current stage processor core 1035 and associated local data memory 1031, and a next stage processor core 1036 and associated local data memory 1037. A processor core can read from its own associated local memory or from the associated memory of the previous stage processor core. However, the processor core may only write to its own associated local memory. For example, processor core 1036 may read from local memory 1031 or local memory 1037, but only writes to local memory 1037.

Each of local data memory 1031 and 1037 can be a single port memory whose read/write port is time-shared as load and store instructions (read and write the local memory) usually are less than 40% of the total instruction counts. Each local data memory 1031 and 1037 can also be a dual-port memory module that is capable of simultaneously supporting two read operations, two write operations, or one read operation and one write operation. Further, every memory entry in local data memory 1031 and 1037 includes data 1034, a valid bit 1032, and an ownership bit 1033. Valid bit 1032 may indicate the validity of the data 1034 in the local data memory 1031 or 1037. For example, a ‘1’ may be used to indicate the corresponding data 1034 is valid for reading, and a ‘0’ may be used to indicate the corresponding data 1034 is invalid for reading.

Ownership bit 1033 may indicate which processor core or processor cores may need to read the corresponding data 1034 in local data memory 1031 or 1037. For example, a ‘0’ may be used to indicate that the data 1034 is only read by a processor core corresponding to the local data memory 1031 (i.e., current stage processor core 1035), and a ‘1’ may be used to indicate that the data 1034 is to be read by both the current stage processor core and a next stage processor core (i.e., next stage processor core 1036). In other words, a ‘0’ in bit 1033 allows the current stage processor core 1035 to overwrite the data 1034 in an entry in local memory 1031 because only current stage processor core 1035 itself reads from this entry.

During operation, the valid bit 1032 and the ownership bit 1033 may be set according to the above definitions to ensure accurate read/write operations on local data memory 1031 and 1037. When the current stage processor core 1035 writes any new data to local data memory 1031, the current stage processor core 1035 sets the valid bit 1032 to ‘1’. The current stage processor core 1035 can also set the ownership bit 1033 to ‘0’ to indicate this data is to be read by current stage processor core 1035 only, or can set the ownership bit 1033 to ‘1’ to indicate this data is intended to be read by both the current stage processor core 1035 and the next stage processor core 1036.

More particularly, when reading data, processor core 1036 first reads from local data memory 1037. If the validity bit 1032 is ‘1’, it indicates that the data entry 1034 is valid in local data memory 1037, and next stage processor core 1036 reads the data entry 1034 from local data memory 1037. If the validity bit 1032 is ‘0’, it indicates that the data entry 1034 in the local data memory 1037 is not valid, and next stage processor core 1036 reads the data entry 1034 with the same address from local data memory 1031 instead, and then writes the read-out data into the local data memory 1037 and sets the validity bit 1032 in local data memory 1037 to ‘1’. This is called a Load Induced Store (LIS). Further, next stage processor core 1036 sets the ownership bit 1033 in local data memory 1031 to ‘0’ (indicating that data has been copied from local data memory 1031 to local data memory 1037 and thus processor core 1035 is allowed to overwrite the data entry in local data memory 1031 if necessary).

Further, a data transfer may be initiated when current stage processor core 1035 tries to write an entry in data memory 1031 where the ownership bit 1033 is “1”. In this case the next stage processor core 1036 may first transfer data 1034 in local data memory 1031 to a corresponding location in the local data memory 1037 associated with the next stage processor core 1036, sets the corresponding validity bit 1032 in local memory 1037 to ‘1’, and then change the ownership bit 1033 of the data entry in local data memory 1031 to ‘0’. The current stage processor core 1035 has to wait until the ownership bit 1033 changes back to ‘0’ and then may store new data in this entry. This process may be called a Store Induced Store (SIS).

The disclosed multi-core structures may also be used in a system-on-chip (SOC) system to significantly improve the SOC system performance. FIG. 11A shows a typical structure of a current SOC system.

As shown in FIG. 11A, central processing unit (CPU) 1101, digital signal processor (DSP) 1102, functional units 1103, 1104, and 1105, input/output control module 1106, and memory control module 1108 are all connected to system bus 1110. The SOC system can exchange data with peripheral 1107 through input/output control module 1106, and access external memory 1109 through memory control module 1108. Further, because normally the functional modules 1103, 1104, and 1105 are specifically-designed IC modules, a CPU or a DSP generally cannot replace these functional modules.

However, unlike the current SOC systems, the disclosed multi-core structures may be used to implement various functional modules such as an image decoding module or an encryption/decryption module. FIG. 11B illustrates an exemplary SOC system structure 1100 consistent with the disclosed embodiments.

As shown in FIG. 11B, SOC system structure 1100 includes a plurality of functional unit having a processor core and associated local memory. One or more functional units can form a functional module. For example, processor core and associated local memory 1121 and other six processor cores and the corresponding local memory may constitute functional module 1124, processor core and corresponding local memory 1122 and other four processor cores and the corresponding local memory may constitute functional module 1125, and processor core and corresponding local memory 1123 and other three processor cores and the corresponding local memory may constitute functional module 1126. Other configurations may also be used.

A functional module may refer to any module capable of performing a defined set of functionalities and may correspond to any of CPU 1101, DSP 1102, functional unit 1103, functional unit 1104, functional unit 1105, input/output control module 1106, and memory control module 1108, as described in FIG. 11A. For example, functional module 1126 includes processor core and associated local memory 1123, processor core and associated local memory 1127, processor core and associated local memory 1128, and processor core and associated local memory 1129. These processor cores constitute a serial-connected multi-core structure to carry out functionalities of function module 1126.

Further, processor core and associated local memory 1123 and processor core and associated local memory 1127 may be coupled through an internal connection 1130 to exchange data. An internal connection may also be called a local connection, a data path for connecting two neighboring processor cores and associated local memory. Similarly, processor core and associated local memory 1127 and processor core and associated local memory 1128 are coupled through an internal connection 1131 to exchange data, and processor core and associated local memory 1128 and processor core and the associated local memory 1129 are coupled through an internal connection 1132 to exchange data.

SOC system structure 1100 may also include a plurality of bus connection modules for connecting the functional modules for data exchange. For example, functional module 1126 may be connected to bus connection module 1138 through hardwire 1133 and hardwire 1134 such that functional module 1126 and the bus connection module 1138 can exchange data. Connections other than hardwires can also be used. Similarly, functional module 1125 and bus connection module 1139 can exchange data, and functional module 1124 and bus connection modules 1140 and 1141 can exchange data.

Bus connection module 1138 and bus connection module 1139 are coupled through hardwire 1135 for data exchange, bus connection module 1139 and bus connection module 1140 are coupled through hardwire 1136 for data exchange, and bus connection module 1140 and bus connection module 1141 are coupled through hardwire 1137 for data exchange. Thus, functional module 1125, functional module 1126, and functional module 1127 can exchange data between each other. That is, the bus connection modules 1138, 1139, 1140, and 1141 and hardwires 1135, 1136, and 1137 perform functions of a system bus (e.g., system bus 1110 in FIG. 11A).

Thus, in SOC system structure 1100, the system bus is formed by using a plurality of connection modules at fixed locations to establish a data path. Any multi-core functional module can be connected to a nearest connection module through one or more hardwires. The plurality of connection modules are also connected with one or more hardwires. The connection modules, the connections between the functional modules and the connection modules, and the connection between the connection modules form the system bus of SOC system structure 1100.

Further, the multi-core structure in SOC system structure 1100 can be scaled to include any appropriate number of processor cores and associated local memory to implement various SOC systems. Further, the functional modules may be re-configured dynamically to change the configuration of the multi-core structure with desired flexibility. For example, FIG. 11C illustrates another configuration of exemplary SOC system structure 1100 consistent with the disclosed embodiments.

As shown in FIG. 11C, similar to FIG. 12B, processor core and associated local memory 1151 and other six processor cores and the corresponding local memory may constitute functional module 1163, processor core and corresponding local memory 1152 and other four processor cores and the corresponding local memory may constitute functional module 1164, and processor core and corresponding local memory 1153 and other three processor cores and the corresponding local memory may constitute functional module 1165. Other configurations may also be used.

Each of functional modules 1163, 1164, and 1165 may correspond to any of CPU 1101, DSP 1102, functional unit 1103, functional unit 1104, functional unit 1105, input/output control module 1106, and memory control module 1108, as described in FIG. 11A. For example, functional module 1165 includes processor core and associated local memory 1153, processor core and associated local memory 1154, processor core and associated local memory 1155, and processor core and associated local memory 1156. These processor cores constitute a serial-connected multi-core structure to carry out functionalities of function module 1165.

Further, processor core and associated local memory 1153 and processor core and associated local memory 1154 may be coupled through an internal connection 1160 to exchange data. Similarly, processor core and associated local memory 1154 and processor core and associated local memory 1155 are coupled through an internal connection 1161 to exchange data, and processor core and associated local memory 1155 and processor core and the associated local memory 1156 are coupled through an internal connection 1162 to exchange data.

Different from FIG. 11B, data exchange between two functional modules is realized by a configurable interconnection among the processor cores and associated local memory. That is, data exchange between two functional modules is performed by corresponding processor cores and associated local memory. For example, data exchange between functional module 1165 and functional module 1164 is realized by data exchange between processor core and associated local memory 1156 and processor core and associated local memory 1166 through interconnection 1158 (i.e., a bi-directional data path).

During operation, when processor core and associated local memory 1156 need to exchange data with processor core and associated local memory 1166, a configurable interconnection network can be automatically configured to establish a bi-directional data path 1158 between processor core and associated local memory 1156 and processor core and associated local memory 1166. Similarly, if processor core and associated local memory 1156 needs to transfer data to processor core and associated local memory 1166 in a single direction, or if processor core and associated local memory 1166 needs to transfer data to processor core and associated local memory 1156 in a single direction, a single-directional data path can be established accordingly.

In addition, bi-directional data path 1157 can be established between processor core and associated local memory 1151 and processor core and associated local memory 1152, and bi-directional data path 1159 can be established between processor core and associated local memory 1165 and processor core and associated local memory 1155. Thus, functional module 1163, functional module 1164, and functional module 1165 can exchange data between each other, and bi-directional data paths 1157, 1158, and 1159 perform functions of a system bus (e.g., system bus 1110 in FIG. 11A).

Therefore, the system bus may also be formed by establishing various data paths such that any processor core and associated local memory can exchange data with any other processor cores and associated local data memory. Such data paths for exchanging data may include exchanging data through shared memory, exchanging data through a DMA controller, and exchanging data through a dedicated bus or network.

For example, one or more configurable hardwires may be placed in advance between certain number of processor cores and corresponding local data memory. When two of these processor cores and corresponding local data memory are configured in two different functional modules, the hardwires between the two processor cores and corresponding local data memory can also be used as the bus between the two functional modules. This data path configuration is static.

Alternatively or additionally, the certain number of processor cores and corresponding local data memory may be able to visit one another by the DMA controller. Thus, when two of these processor cores and corresponding local data memory are configured in two different functional modules, the DMA path between the two processor cores and corresponding local data memory can also be used as the bus between the two functional modules. This data path configuration is thus dynamic.

Further, alternatively or additionally, the certain number of processor cores and corresponding local data memory may be configured to use a network-on-chip function. That is, when a processor core and corresponding local data memory needs to exchange data with other processor cores and corresponding local data memory, the destination and path of the data are determined by the network (e.g., the Internet), so as to establish a data path for data exchange. When two of these processor cores and corresponding local data memory are configured in two different functional modules, the network path between the two processor cores and corresponding local data memory can also be used as the bus between the two functional modules. This data path configuration is also dynamic.

Further, more than one data paths may be configured between any two functional modules. The disclosed multi-core structure in SOC system structure 1100 can thus be easily scaled to include any appropriate number of processor cores and associated local memory to implement various SOC systems. Further, the functional modules may be re-configured dynamically to change the configuration of the multi-core structure with desired flexibility.

FIG. 13A illustrates another exemplary multi-core structure 1300 consistent with the disclosed embodiments. As shown in FIG. 13A, multi-core structure 1300 may include a plurality of processor cores and configurable local memory 1301, 1303, 1305, 1307, 1309, 1311, 1313, 1315, and 1317. The multi-core structure 1300 may also include a plurality of configurable interconnect modules (CIM) 1302, 1304, 1306, 1308, 1310, 1312, 1314, 1316, and 1318. Each processor core and corresponding configurable local memory can form one stage of the macro pipeline. That is, through the plurality of configurable interconnect modules, multiple processor cores and corresponding configurable local memory can be configured to constitute a serially-connected multi-core structure operating a macro pipeline.

That is, based on particular applications, the processor cores, configurable local memory, and configurable interconnect modules may be configured based on configuration information. For example, a processor core may be turned on or off, configurable memory may be configured with respect to the size, boundary, and contents of the instruction memory (e.g., the code segment) and data memory including sub-modules, and configurable interconnect modules may be configured to form interconnect structures and connection relationships.

The configuration information may come from internally the multi-core structure 1300 or may be from an external source. The configuration of multi-core structure 1300 may be adjusted during operation based on application programs, and such configuration or adjustment may be performed by the processor core directly, through a direct memory access to a controller by the processor core, or through a direct memory access to a controller by the an external request, etc.

It is understood that the plurality of processor cores may be of the same structure or of different structures, and the lengths of instructions for different processor cores may be different. The clock frequencies of different processor cores may also be different.

Further, multi-core structure 1300 may be configured to include multiple serial-connected multi-core structures. The multiple serial-connected multi-core structures may operate independently, or several or all serial-connected multi-core structures may be correlated to form serial, parallel, or serial and parallel configurations to execute computer programs, and such configuration can be done dynamically during run-time or statically.

In addition, multi-core structure 1300 may be configured with power management mechanisms to reduce power consumption during operation. The power management may be performed at different levels, such as at a configuration level, an instruction level, and an application level.

More particularly, at the configuration level, when a processor core is not used for operation, the processor core may be configured to be in a low-power state, such as reducing the processor clock frequency or cutting off the power supply to the processor core.

At the instruction level, when a processor core executes an instruction to read data, if the data is not ready, the processor core can be put into a low-power state until the data is ready. For example, if a previous stage processor core has not written data required by the current stage processor core in certain data memory, the data is not ready, and the current stage processor core may be put into the low-power state, such as reducing the processor clock frequency or cutting off the power supply to the processor core.

Further, at the application level, idle task feature matching may be used to determine a current utilization rate of a processor core. The utilization rate may be compared with a standard utilization rate to determine whether to enter a low-power state or whether to return from a low-power state. The standard utilization rate may be fixed, reconfigurable, or self-learned during operation. The standard utilization rate may also be fixed inside the chip, written into the processor core during startup, or written by a software program. The content of the idle task may be fixed inside the chip, written during startup or by the software program, or self-learned during operation.

FIG. 13B shows an exemplary all serial configuration of multi-core structure 1300. As shown in FIG. 13B, all processor cores and corresponding configurable local memory 1301, 1303, 1305, 1307, 1309, 1311, 1313, 1315, and 1317 are serially connected to form a single serial multi-core processor. Among them, processor core and configurable local memory 1301 may be the first stage of the macro pipeline, and processor core and configurable local memory 1317 may be the last stage of the macro pipeline.

FIG. 13C shows an exemplary serial and parallel configuration of multi-core structure 1300. By configuring the corresponding configurable interconnect modules, processor cores and configurable local memory 1301, 1303, and 1305 form a serial-connected multi-core structure, and processor cores and configurable local memory 1313, 1315, and 1317 also form a serial-connected multi-core structure. However, the processor cores and configurable local memory 1307, 1309, and 1311 form a parallel-connected multi-core structure. Further, these multi-core structures are further connected to form a combined serial and parallel multi-core processor.

FIG. 13D shows another exemplary configuration of multi-core structure 1300. By configuring the corresponding configurable interconnect modules, processor cores and configurable local memory 1301, 1307, 1313, and 1315 form a first serial-connected multi-core structure. Further, the processor cores and configurable local memory 1303, 1309, 1305, 1311, and 1317 form a second serial-connected multi-core structure. These two multi-core structures operate independently.

Some of the multiple multi-core structures, whether in a serial connection or a parallel connection, may be configured as one or more dedicated processing modules, whose configurations may not be changed during operation. The dedicated processing modules can be used as a macro block to be called by other modules or processor cores and configurable local memory. The dedicated processing modules may also be independent and can receive inputs from other modules or processor cores and configurable local memory and send outputs to modules or processor cores and configurable local memory. The module or processor core and configurable local memory sending an input to a dedicated processing module may be the same as or different from the module or processor core and configurable local memory receiving the corresponding output from the dedicated processing module. The dedicated processing module may include a fast Fourier transform (FFT) module, an entropy coding module, an entropy decoding module, a matrix multiplication module, a convolutional coding module, a Viterbi code decoding module, and a turbo code decoding module, etc.

Using the matrix multiplication module as an example, if a single processor core is used to perform a large-scale matrix multiplication, a large number of clock cycles may be needed, limiting the data throughput. On the other hand, if several processor cores are configured to perform the large-scale matrix multiplication, although the number of clock cycles is reduced, the amount of data exchange among the processor cores is increased and a large amount of resources are occupied. However, using the dedicated matrix multiplication module, the large-scale matrix multiplication can be completed in a small number of clock cycles without extra data bandwidth.

Further, when segmenting a program including a large-scale matrix multiplication, programs before the matrix multiplication can be segmented to a first group of processor cores, and programs after the matrix multiplication can be segmented to a second group of processor cores. The large-scale matrix multiplication program is segmented to the dedicated matrix multiplication module. Thus, the first group of processor cores sends data to the dedicated matrix multiplication module, and the dedicated matrix multiplication module performs the large-scale matrix multiplication and sends outputs to the second group of processor cores. Meanwhile, data that does not require matrix multiplication can be directly sent to the second group of processor cores by the first group of processor cores.

The disclosed systems and methods can segment serial programs into code segments to be used by individual processor cores in a serially-connected multi-core structure. The code segments are generated based on the number of processor cores and thus can provide scalable multi-core systems.

The disclosed systems and methods can also allocate code segments to individual processor cores, and each processor core executes a particular code segment. The serially-connected processor cores together execute the entire program and the data between the code segments are transferred in dedicated data paths such that data coherence issue can be avoided and a true multi-issue can be realized. In such serially-connected multi-core structures, the number of the multi-issue is equal to the number of the processor cores, which greatly improves the utilization of execution units and achieve significantly high system throughput.

Further, the disclosed systems and methods replace the common cache used by processors with local memory. Each processor core keeps instructions and data in the associated local memory so as to achieve 100% hit rate, solving the bottleneck issue caused by a cache miss and later low speed access to external memory and further improving the system performance. Also, the disclosed systems and methods apply various power management mechanisms at different levels.

In addition, the disclosed systems and methods can realize an SOC system by programming and configuration to significantly shorten the product development cycle from product design to marketing. Further, a hardware product with different functionalities can be made from an existing one by only re-programming and re-configuration. Other advantages and applications are obvious to those skilled in the art.

What is claimed is:

1. A configurable multi-core structure for executing a program, comprising:
a plurality of processor cores;
a plurality of configurable local memory respectively associated with the plurality of processor cores; and
a plurality of configurable interconnect structures for serially interconnecting the plurality of processor cores,
wherein:
each processor core is configured to execute a segment of the program in a sequential order such that the serially-interconnected processor cores execute the entire program in a pipelined way;
the segment of the program for one processor core is stored in the configurable local memory associated with the one processor core along with operation data to and from the one processor core.

2. The multi-core structure according to claim 1, wherein:
a processor core operates in an internal pipeline with one or more issues; and
the plurality of processor cores operate in a macro pipeline where each processor core is a stage of the macro pipeline to achieve a large number of issues.

3. The multi-core structure according to claim 1, wherein:
the program is divided into a plurality of code segments respectively for the plurality of processor cores based on configuration information of the multi-core structure such that each code segment has a substantially similar number of execution cycles; and
the code segments are divided through a segmentation process including:
a pre-compiling process for substituting a function call in the program with a code section called;
a compiling process for converting source code of the program to object code of the program; and
a post-compiling process for segmenting the object code into the code segments and adding guiding codes to the code segments.

4. The multi-core structure according to claim 3, wherein:
when one code segment includes a loop and a loop count of the loop is greater than an available loop count of the code segment, the loop is further divided into two or more sub-loops, such that the one code segment only contains a sub-loop.

5. The multi-core structure according to claim 1, further including:
one or more extension module; and
the module includes a shared memory for storing overflow data from the configurable local memory and for transferring data shared among the processor cores, a direct memory access (DMA) controller for directly accessing the configurable local memory, or an exception handling module for processing exceptions from the processor cores and the configurable local memory,
wherein each processor core includes an execution unit and a program counter.

6. The multi-core structure according to claim 1, wherein:
each configurable local memory includes an instruction memory and a configurable data memory, and the boundary between the instruction memory and configurable data memory is configurable.

7. The multi-core structure according to claim 6, wherein:
the configurable data memory includes a plurality of sub-modules and the boundary between the sub-modules is configurable.

8. The multi-core structure according to claim 5, wherein:
the configurable interconnect structures include connections between the processor cores and the configurable local memory, connections between the processor cores and the share memory, connections between the processor cores and the DMA controller, connections between the configurable local memory and the shared memory, connections between the configurable local memory and the DMA controller, connections between the configurable local memory and an external system, and connections between the shared memory and the external system.

9. The multi-core structure according to claim 2, wherein:
the macro pipeline is controlled by a back-pressure signal passed between two neighboring stages of the macro pipeline for a previous stage to determine whether a current stage is stalled.

10. The multi-core structure according to claim 1, wherein the processor cores are configured to have a plurality of power management modes including:
a configuration level power management mode where a processor core not in operation is put in a low-power state;
an instruction level power management mode where a processor core waiting for a completion of data access is put in a low-power state; and
an application level power management mode where a processor core with a current utilization rate below a threshold is put in a low-power state.

11. The multi-core structure according to claim 1, further including:
a self-testing facility for generating testing vectors and storing testing results such that a processor core can compare operation results with neighboring processor cores using a same set of testing vectors to determine whether the processor core is running normally,
wherein any processor core that is not running normally is marked as invalid such that the marked-as-invalid processor core is not configured into the macro pipeline to achieve self-repairing capability.

12. A system-on-chip (SOC) system comprising at least one multi-core structure according to claim 1, further including:
a plurality of parallelly-interconnected processor cores, wherein the plurality of serially-interconnected processor cores and the plurality of parallelly-interconnected processor cores are coupled together to form a combined serial and parallel multi-core SOC system.

13. A system-on-chip (SOC) system comprising at least a first multi-core structure according to claim 1, further including:
a second plurality of serially-interconnected processor cores operating independently with the plurality of serially-interconnected processor cores in the first multi-core structure.

14. A system-on-chip (SOC) system comprising a plurality of functional modules each corresponding to a multi-core structure according to claim 1, further including:
a plurality of bus connection modules coupled to the plurality of functional modules for exchanging data;
multiple data paths between the bus connection modules to form a system bus, together with the plurality of bus connection modules and connections between the bus connection modules and the functional modules,
wherein the system bus further includes preset interconnections between two processor cores in different functional modules; and
the functional modules include a dedicated functional module that is statically configured for performing a dedicated data processing and configured to be called dynamically by other functional modules.

15. A configurable multi-core structure for executing a program, comprising:
a first processor core configured to be a first stage of a macro pipeline operated by the multi-core structure and to execute a first code segment of the program;
a first configurable local memory associated with the first processor core and containing the first code segment;
a second processor core configured to be a second stage of the macro pipeline and to execute a second code segment of the program, wherein the second code segment has a substantially similar number of execution cycles to that of the first code segment;
a second configurable local memory associated with the second processor core and containing the second code segment; and
a plurality of configurable interconnect structures for serially interconnecting the first processor core and the second processor core.

16. The multi-core structure according to claim 15, wherein:
the first processor core is configured with a first read policy defining a first source for data input to the first processor core including one of the first configurable local memory, a shared memory, and external devices;
the second processor core is configured with a second read policy defining a second source for data input to the second processor core including the second configurable local memory, the first configurable local memory, the shared memory, and the external devices;
the first processor core is configured with a first write policy defining a first destination for data output from the first stage processor core including the first configurable local memory, the shared memory, and the external devices; and
the second processor core is configured with a second write policy defining a second destination for data output from the first stage processor core including the second configurable local memory, the shared memory, and the external devices.

17. The multi-core structure according to claim 15, wherein:
the first configurable local memory includes a plurality of data sub-modules to be accessed by the first processor core and the second processor core separately at the same time;
when each of the first and second processor cores includes a register file, values of registers in the register file of the first processor core are transferred to corresponding registers in the register file of the second processor core during operation.

18. The multi-core structure according to claim 15, wherein:
an entry in both the first configurable local memory and the second configurable local memory includes a data portion, a validity flag indicating whether the data portion is valid, and an ownership flag indicating whether the data is to be read by the first processor core or by the first and second processor cores; and
when the second processor reads from an address for the first time, the second processor core reads from the first configurable local memory and stores read-out data in the second configurable local memory such that any subsequent access can be performed from the second configurable local memory to achieve load-induced-store (LIS) operation.
